(19) United States
(12) Patent Application Publication
(10) Pub. No.: US 2022/0410528 A1
(43) Pub. Date: Dec. 29, 2022

(54) MULTILAYER COMPOSITE WITH THERMAL BARRIER PROPERTIES

(71) Applicant: SAINT-GOBAIN PERFORMANCE PLASTICS CORPORATION, Solon, OH (US)

(72) Inventors: Fei WANG, Winchester, MA (US); Jan Faltin, Monchengladbach (DE); Senthil Jayaseelan, Mechanicville, NY (US); Roger P. Zaleski, North Grafton, MA (US); Rachel Brown, Shrewsbury, MA (US); Stany Janicki, Thimister-Clermont (BE); Benoit Didier, Liege (BE); Yue Dong, Shanghai (CN); Jing Zhou, Shanghai (CN); Wenqing Tian, Shanghai (CN)

(21) Appl. No.: 17/804,138

(22) Filed: May 26, 2022

Related U.S. Application Data
(60) Provisional application No. 63/220,066, filed on Jul. 9, 2021.

(30) Foreign Application Priority Data
Jun. 28, 2021 (CN) 202110719239.4

(51) Int. Cl. B32B 7/027; B32B 5/18; B32B 27/06; B32B 27/20; B32B 27/40; B32B 33/00

(52) U.S. Cl. CPC B32B 7/027; B32B 5/18; B32B 27/065; B32B 27/20; B32B 27/40; B32B 33/00; B32B 2250/04; B32B 2250/40; B32B 2260/046; B32B 2264/108; B32B 2266/0278; B32B 2305/022; B32B 2305/30; B32B 2307/306; B32B 2313/04; B32B 2375/00; B32B 2457/10

(57) ABSTRACT

The present disclosure relates to a multilayer composite that may include a first barrier layer and a first foam layer. The first foam layer may include a polyurethane-based matrix component, and a flame retardant filler component. The multilayer component may also have a HBF flammability rating as measured according to ASTM D4986.

### CROSS-REFERENCE TO RELATED APPLICATION(S)

This application claims priority to Chinese Patent Application No. 202110719239.4, entitled “MULTILAYER COMPOSITE WITH THERMAL BARRIER PROPERTIES,” by Fei Wang et al., filed Jun. 28, 2021, which is assigned to the current assignee hereof and incorporated herein by reference in its entirety. This application further claims priority under 35 U.S.C. § 119(e) to U.S. Provisional Patent Application No. 63/220,066, entitled “MULTILAYER COMPOSITE WITH THERMAL BARRIER PROPERTIES,” by Fei Wang et al., filed Jul. 9, 2021, which is assigned to the current assignee hereof and incorporated herein by reference in its entirety.

### FIELD OF THE DISCLOSURE

The present disclosure relates to a multilayer composite and, in particular, a multilayer composite for use as a thermal barrier in various applications, for example, in a battery pack, and methods of forming the same.

### BACKGROUND

Multilayer composite films may be designed for high temperature protection in various applications, for example, for use as thermal barriers in electric vehicle battery packs, thermal barrier coverings in high temperature cable protection, thermal barrier containers for thermal spray containment, etc. However, in these, and in other applications, potential heat growth continues to increase due to improvements in technology. Accordingly, there is a continuing need for improved barrier designs that protect against such high heat potential.

### SUMMARY

According to a first aspect, a multilayer composite may include a first barrier layer and a first foam layer. The first foam layer may include a polyurethane-based matrix component, and a flame retardant filler component. The multilayer component may also have a HBF flammability rating as measured according to ASTM D4986.

According to still another aspect, a multilayer composite may include a first barrier layer and a first foam layer. The first foam layer may include a polyurethane-based matrix component, and a flame retardant filler component. The first barrier layer may comprise a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof. The flame retardant filler component of the first foam layer may include a filler selected from the group consisting of reactive charring agents, mineral compounds, endothermic decomposition compounds, and any combination thereof.

According to another aspect, a thermal barrier composite may include a first barrier layer and a first foam layer. The first foam layer may include a polyurethane-based matrix component, and a flame retardant filler component. The multilayer component may also have a HBF flammability rating as measured according to ASTM D4986.

According to still another aspect, a thermal barrier composite may include a first barrier layer and a first foam layer. The first foam layer may include a polyurethane-based matrix component, and a flame retardant filler component. The first barrier layer may comprise a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof. The flame retardant filler component of the first foam layer may include a filler selected from the group consisting of reactive charring agents, mineral compounds, endothermic decomposition compounds, and any combination thereof.

### BRIEF DESCRIPTION OF THE DRAWINGS

Embodiments are illustrated by way of example and are not limited to the accompanying figures.

FIG. 1 includes an illustration of an example multilayer composite according to certain embodiments described herein;

FIG. 2 includes an illustration of an example multilayer composite according to certain embodiments described herein;

FIG. 3 includes an illustration of an example multilayer composite according to certain embodiments described herein;

FIG. 4 includes an illustration of an example thermal barrier composite according to certain embodiments described herein;

FIG. 5 includes an illustration of an example thermal barrier composite according to certain embodiments described herein; and

FIG. 6 includes an illustration of an example thermal barrier composite according to certain embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a multilayer composite that may include a first barrier layer and a first foam layer. According to particular embodiments, the first foam layer may include a polyurethane-based matrix component, and a flame retardant filler component. According to still other embodiments, the multilayer composite may demonstrate a combination of improved performance in flame resistance and compression.

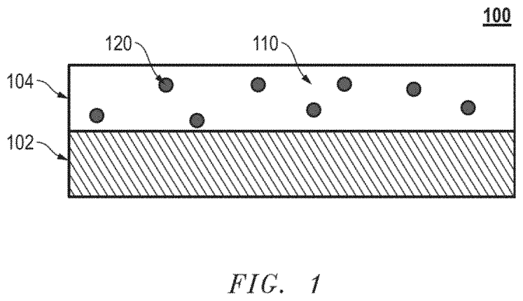

For purposes of illustration, FIG. 1 shows a multilayer composite 100 according to embodiments described herein. As shown in FIG. 1, a multilayer composite 100 may include a first barrier layer 102 and a first foam layer 104. The first foam layer 104 may include a polyurethane-based matrix component 110, and a flame retardant filler component 120.

According to particular embodiments, the polyurethane-based matrix component 110 of the first foam layer 104 may include a particular material. For example, the polyurethane-based matrix component 110 of the first foam layer 104 may include a flexible polyurethane reacted from isocyanate and polyol.

According to particular embodiments, the polyurethane-based matrix component 110 of the first foam layer 104 may consist of a particular material. For example, the polyurethane-based matrix component 110 of the first foam layer 104 may consist of a flexible polyurethane reacted from isocyanate and polyol.

According to particular embodiments, the polyurethane-based matrix component 110 of the first foam layer 104 may be a layer of a particular material. For example, the polyurethane-based matrix component 110 of the first foam layer 104 may be a flexible polyurethane layer, which is reacted from isocyanate and polyol.

According to yet other embodiments, the flame retardant filler component 120 may be selected from a particular group of materials. For example, the flame retardant filler component 120 may be a filler selected from the group consisting of reactive charring agents, mineral compounds, endothermic decomposition compounds, and any combination thereof.

According to still other embodiments, the flame retardant filler component 120 may include a particular material. For example, the flame retardant filler component 120 may include reactive charring agents. It will be appreciated that a reactive charring agent may be defined as a compound that can react with a carbon source, such as a polymer material, at high temperatures to form a carbon layer. According to still other embodiments, the flame retardant filler component 120 may include melamine. According to yet other embodiments, the flame retardant filler component 120 may include organic phosphorous compounds. According to still other embodiments, the flame retardant filler component 120 may include inorganic phosphorous compounds. According to yet other embodiments, the flame retardant filler component 120 may include metal salts. According to yet other embodiments, the flame retardant filler component 120 may include mineral compounds. According to still other embodiments, the flame retardant filler component 120 may include endothermic decomposition compounds. According to other embodiments, the flame retardant filler component 120 may include any combination of reactive charring agents, melamine, organic phosphorous compounds, inorganic phosphorous compounds, metal salts, mineral compounds, or endothermic decomposition compounds.

According to still other embodiments, the flame retardant filler component 120 may consist of a particular material. For example, the flame retardant filler component 120 may consist of reactive charring agents. According to still other embodiments, the flame retardant filler component 120 may consist of melamine. According to yet other embodiments, the flame retardant filler component 120 may consist of organic phosphorous compounds. According to still other embodiments, the flame retardant filler component 120 may consist of inorganic phosphorous compounds. According to yet other embodiments, the flame retardant filler component 120 may consist of metal salts. According to yet other embodiments, the flame retardant filler component 120 may consist of mineral compounds. According to still other embodiments, the flame retardant filler component 120 may consist of endothermic decomposition compounds. According to other embodiments, the flame retardant filler component 120 may consist of any combination of reactive charring agents, melamine, organic phosphorous compounds, inorganic phosphorous compounds, metal salts, mineral compounds, or endothermic decomposition compounds.

According to still other embodiments, the flame retardant filler component 120 may be a filler of a particular material. For example, the flame retardant filler component 120 may be a filler of reactive charring agents. According to still other embodiments, the flame retardant filler component 120 may be a filler of melamine. According to yet other embodiments, the flame retardant filler component 120 may be a filler of organic phosphorous compounds. According to still other embodiments, the flame retardant filler component 120 may be a filler of inorganic phosphorous compounds. According to yet other embodiments, the flame retardant filler component 120 may be a filler of metal salts. According to yet other embodiments, the flame retardant filler component 120 may be a filler of mineral compounds. According to still other embodiments, the flame retardant filler component 120 may be a filler of endothermic decomposition compounds. According to other embodiments, the flame retardant filler component 120 may be a filler of any combination of reactive charring agents, melamine, organic phosphorous compounds, inorganic phosphorous compounds, metal salts, mineral compounds, or endothermic decomposition compounds.

According to yet other embodiments, the flame retardant filler component 120 may include a particular organic phosphorous compound or inorganic phosphorous compound. For example, the flame retardant filler component 120 may include a phosphate. According to yet other embodiments, the flame retardant filler component 120 may include a phosphonate. According to yet other embodiments, the flame retardant filler component 120 may include a phosphinate. According to a particular embodiment, the flame retardant filler component 120 may include any combination of a phosphate, a phosphonate, or a phosphinate.

According to yet other embodiments, the flame retardant filler component 120 may consist of a particular organic phosphorous compound or inorganic phosphorous compound. For example, the flame retardant filler component 120 may consist of a phosphate. According to yet other embodiments, the flame retardant filler component 120 may consist of a phosphonate. According to yet other embodiments, the flame retardant filler component 120 may consist of a phosphinate. According to a particular embodiment, the flame retardant filler component 120 may consist of any combination of a phosphate, a phosphonate, or a phosphinate.

According to yet other embodiments, the flame retardant filler component 120 may be a filler of a particular organic phosphorous compound or inorganic phosphorous compound. For example, the flame retardant filler component 120 may be a filler of a phosphate. According to yet other embodiments, the flame retardant filler component 120 may be a filler of a phosphonate. According to yet other embodiments, the flame retardant filler component 120 may be a filler of a phosphinate. According to a particular embodiment, the flame retardant filler component 120 may be a filler of any combination of a phosphate, a phosphonate, or a phosphinate.

According to still other embodiments, the flame retardant filler component 120 may include a particular metal salt. For example, the flame retardant filler component 120 may include aluminum diethyl phosphinate.

According to still other embodiments, the flame retardant filler component 120 may consist of a particular metal salt. For example, the flame retardant filler component 120 may consist of aluminum diethyl phosphinate.

According to still other embodiments, the flame retardant filler component 120 may be a filler of a particular metal salt. For example, the flame retardant filler component 120 may be a filler of aluminum diethyl phosphinate. According to still other embodiments, the flame retardant filler component 120 may include a particular mineral compound. For example, the flame retardant filler component 120 may include expandable graphite.

According to still other embodiments, the flame retardant filler component 120 may consist of a particular mineral compound. For example, the flame retardant filler component 120 may consist of expandable graphite.

According to still other embodiments, the flame retardant filler component 120 may be a filler of a particular mineral compound. For example, the flame retardant filler component 120 may be an expandable graphite filler.

According to yet other embodiments, the flame retardant filler component 120 may include a particular endothermic decomposition compound. For example, the flame retardant filler component 120 may include a metal hydrate. According to still other embodiments, the flame retardant filler component 120 may include a metal silicate. According to yet other embodiments, the flame retardant filler component 120 may include a carbonate. According to a particular embodiment, the flame retardant filler component 120 may include aluminum trihydrate. According to still other embodiments, the flame retardant filler component 120 may include zinc borate. According to yet other embodiments, the flame retardant filler component 120 may include any combination of a metal hydrate, a metal silicate, a carbonate, aluminum trihydrate, or zinc borate.

According to yet other embodiments, the flame retardant filler component 120 may consist of a particular endothermic decomposition compound. For example, the flame retardant filler component 120 may consist of a metal hydrate. According to still other embodiments, the flame retardant filler component 120 may consist of a metal silicate. According to yet other embodiments, the flame retardant filler component 120 may consist of a carbonate. According to a particular embodiment, the flame retardant filler component 120 may consist of aluminum trihydrate. According to still other embodiments, the flame retardant filler component 120 may consist of zinc borate. According to yet other embodiments, the flame retardant filler component 120 may consist of any combination of a metal hydrate, a metal silicate, a carbonate, aluminum trihydrate, or zinc borate.

According to yet other embodiments, the flame retardant filler component 120 may be a filler of a particular endothermic decomposition compound. For example, the flame retardant filler component 120 may be a metal hydrate filler. According to still other embodiments, the flame retardant filler component 120 may be a metal silicate filler. According to yet other embodiments, the flame retardant filler component 120 may be a carbonate filler. According to a particular embodiment, the flame retardant filler component 120 may be an aluminum trihydrate filler. According to still other embodiments, the flame retardant filler component 120 may be a filler of zinc borate. According to yet other embodiments, the flame retardant filler component 120 may be a filler of any combination of a metal hydrate, a metal silicate, a carbonate, aluminum trihydrate, or zinc borate.

According to certain embodiments, the first foam layer 104 may include a particular content of the polyurethane-based matrix component 110. For example, the first foam layer 104 may include a polyurethane-based matrix component content of at least about 40 wt. % for a total weight of the first foam layer 104, such as, at least about 45 wt. % or at least about 50 wt. % or at least about 55 wt. % or at least about 60 wt. % or at least about 65 wt. % or even at least about 70 wt. %. According to yet other embodiments, the first foam layer 104 may include a polyurethane-based matrix component content of not greater than about 95 wt. % for a total weight of the first foam layer 104, such as, not greater than about 90 wt. % or not greater than about 85 wt. % or not greater than about 80 wt. % or even not greater than about 75 wt. %. It will be appreciated that the polyurethane-based matrix component content of the first foam layer 104 may be within a range between any of the values noted above. It will be further appreciated that the polyurethane-based matrix component content of the first foam layer 104 may be any value between any of the minimum and maximum values noted above.

According to still other embodiments, the first foam layer 104 may include a particular content of flame retardant filler component 120. For example, the first foam layer 104 may include a flame retardant filler component content of at least about 5 wt. % for a total weight of the first foam layer 104, such as, at least about 10 wt. % or at least about 15 wt. % or at least about 20 wt. % or at least about 25 wt. % or at least about 30 wt. % or even at least about 35 wt. %. According to yet other embodiments, the first foam layer 104 may include a flame retardant filler component content of not greater than about 60 wt. % for a total weight of the first foam layer 104, such as, not greater than about 55 wt. % or not greater than about 50 wt. % or not greater than about 45 wt. % or even not greater than about 40 wt. %. It will be appreciated that the flame retardant filler component content of the first foam layer 104 may be within a range between any of the minimum and maximum values noted above. It will be further appreciated that the flame retardant filler component content of the first foam layer 104 may be any value between any of the minimum and maximum values noted above.

According to certain embodiments, the first foam layer 104 may have a particular flammability rating as measured according to ASTM D4986. In particular, the foam layer may have a HFB flammability rating as measured according to ASTM D4986.

According to certain embodiments, the multilayer composite 100 may have a particular flammability rating as measured according to ASTM D4986. In particular, the foam layer may have a HFB flammability rating as measured according to ASTM D4986.

According to still other embodiments, the first foam layer 104 may have a particular cold-side temperature as measured at 5 minutes when a 3 mm thickness of the foam is exposed to a hot plate test at 650° C. For purposes of embodiments described herein, the hot plate test is carried out by preparing a 1-inch by 1-inch specimen of the material, which is put on top of a hot plate. Then a thermal couple is fixed in a steel weight (1 inch in diameter, 2 inches in height) is put on top of the specimen to measure the cold side surface temperature. According to certain embodiments, the first foam layer 104 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the first foam layer 104 may have a cold side temperature of at least about 25° C. It will be appreciated that the cold side temperature of the first foam layer 104 may be within a range between any of the values noted above. It will be further appreciated that the cold side temperature of the first foam layer 104 may be any value between any of the values noted above.

According to still other embodiments, the multilayer composite 100 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the multilayer composite 100 may have a cold side temperature of not greater than about 300° C., such as, not greater than about 275° C. or not greater than about 250° C. or not greater than about 225° C. or not greater than about 200° C. or not greater than about 175° C. or even not greater than about 150° C. According to still other embodiments, the multilayer composite 100 may have a cold side temperature of at least about 25° C. It will be appreciated that the cold side temperature of the multilayer composite 100 may be within a range between any of the values noted above. It will be further appreciated that the cold side temperature of the multilayer composite 100 may be any value between any of the values noted above.

According to yet other embodiments, the first foam layer 104 may have a particular thickness. For example, the first foam layer 104 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the first foam layer 104 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the first foam layer 104 may be within a range between any of the minimum and maximum values noted above. It will be further appreciated that the thickness of the first foam layer 104 may be any value between any of the minimum and maximum values noted above.

According to yet other embodiments, the multilayer composite 100 may have a particular thickness. For example, the multilayer composite 100 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the multilayer composite 100 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the multilayer composite 100 may be within a range between any of the minimum and maximum values noted above. It will be further appreciated that the thickness of the multilayer composite 100 may be any value between any of the minimum and maximum values noted above.

According to yet other embodiments, the first foam layer 104 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the first foam layer 104 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the first foam layer 104 may have a 25% strain compression rating of at least about 5 kPa, such as, at least about 10 kPa or at least about 15 kPa or at least about 20 kPa or at least about 25 kPa. It will be appreciated that the 25% strain compression rating of the first foam layer 104 may be within a range between any of the minimum and maximum values noted above. It will be further appreciated that the 25% strain compression rating of the first foam layer 104 may be any value between any of the minimum and maximum values noted above.

According to yet other embodiments, the multilayer composite 100 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the multilayer composite 100 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the multilayer composite 100 may have a 25% strain compression rating of at least about 5 kPa, such as, at least about 10 kPa or at least about 15 kPa or at least about 20 kPa or at least about 25 kPa. It will be appreciated that the 25% strain compression rating of the multilayer composite 100 may be within a range between any of the minimum and maximum values noted above. It will be further appreciated that the 25% strain compression rating of the multilayer composite 100 may be any value between any of the minimum and maximum values noted above.

According to yet other embodiments, the first foam layer 104 may have a particular density. For the purpose of embodiments described herein, the density of the first foam layer 104 may be determined according to ASTM D1056. According to certain embodiments, the first foam layer 104 may have a density of not greater than about 600 kg/m³, such as, not great than about 575 kg/m³ or not greater than about 550 kg/m³ or not greater than about 525 kg/m³ or not greater than about 500 kg/m³ or not greater than about 450 kg/m³ or not greater than about 400 kg/m³ or not greater than about 350 kg/m³ or even not greater than about 300 kg/m³. According to yet other embodiments, the first foam layer 104 may have a density of at least about 50 kg/m³, such as, at least about 60 kg/m³ or at least about 80 kg/m³ or at least about 100 kg/m³ or at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the first foam layer 104 may be within a range between any of the minimum and maximum values noted above. It will be further appreciated that the density of the first foam layer 104 may be any value between any of the minimum and maximum values noted above.

According to yet other embodiments, the multilayer composite 100 may have a particular density. For the purpose of embodiments described herein, the density of the multilayer composite 100 may be determined according to ASTM D1056. According to certain embodiments, the multilayer composite 100 may have a density of not greater than about 600 kg/m³, such as, not great than about 575 kg/m³ or not greater than about 550 kg/m³ or not greater than about 525 kg/m³ or not greater than about 500 kg/m³ or not greater than about 450 kg/m³ or not greater than about 400 kg/m³ or not greater than about 350 kg/m³ or even not greater than about 300 kg/m³. According to yet other embodiments, the multilayer composite 100 may have a density of at least about 50 kg/m³, such as, at least about 60 kg/m³ or at least about 80 kg/m³ or at least about 100 kg/m³ or at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the multilayer composite 100 may be within a range between any of the minimum and maximum values noted above. It will be further appreciated that the density of the multilayer composite 100 may be any value between any of the minimum and maximum values noted above.

According to yet other embodiments, the first foam layer 104 may have a particular thermal conductivity as measured according to ASTM C518. For example, the first foam layer 104 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the first foam layer 104 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the first foam layer 104 may be within a range between any of the minimum and maximum values noted above. It will be further appreciated that the thermal conductivity of the first foam layer 104 may be any value between any of the minimum and maximum values noted above.

According to yet other embodiments, the multilayer composite 100 may have a particular thermal conductivity as measured according to ASTM C518. For example, the multilayer composite 100 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the multilayer composite 100 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the multilayer composite 100 may be within a range between any of the minimum and maximum values noted above. It will be further appreciated that the thermal conductivity of the multilayer composite 100 may be any value between any of the minimum and maximum values noted above.

According to still other embodiments, the first barrier layer 102 may be a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

According to still other embodiments, the first barrier layer 102 may include a particular material. For example, the first barrier layer 102 may include mica. According to still other embodiments, the first barrier layer 102 may include a mica-fiber glass composite. According to yet other embodiments, the first barrier layer 102 may include a glass fabric. According to other embodiments, the first barrier layer 102 may include a silica fabric. According to still other embodiments, the first barrier layer 102 may include a basalt fabric. According to yet other embodiments, the first barrier layer 102 may include a vermiculite coated glass fabric. According to other embodiments, the first barrier layer 102 may include an aerogel. According to yet other embodiments, the first barrier layer 102 may include a non-woven glass fabric. According to still other embodiments, the first barrier layer 102 may include any combination of mica, a mica-fiber glass composite, a glass fabric, a silica fabric, a basalt fabric, a vermiculite coated glass fabric, an aerogel, or a non-woven glass fabric. According to yet other embodiments, the first barrier layer 102 may include any lamination of mica, a mica-fiber glass composite, a glass fabric, a silica fabric, a basalt fabric, a vermiculite coated glass fabric, an aerogel, or a non-woven glass fabric.

According to still other embodiments, the first barrier layer 102 may consist of a particular material. For example, the first barrier layer 102 may consist of mica. According to still other embodiments, the first barrier layer 102 may consist of a mica-fiber glass composite. According to yet other embodiments, the first barrier layer 102 may consist of a glass fabric. According to other embodiments, the first barrier layer 102 may consist of a silica fabric. According to still other embodiments, the first barrier layer 102 may consist of a basalt fabric. According to yet other embodiments, the first barrier layer 102 may consist of a vermiculite coated glass fabric. According to other embodiments, the first barrier layer 102 may consist of an aerogel. According to yet other embodiments, the first barrier layer 102 may consist of a non-woven glass fabric. According to still other embodiments, the first barrier layer 102 may consist of any combination of mica, a mica-fiber glass composite, a glass fabric, a silica fabric, a basalt fabric, a vermiculite coated glass fabric, an aerogel, or a non-woven glass fabric. According to yet other embodiments, the first barrier layer 102 may consist of any lamination of mica, a mica-fiber glass composite, a glass fabric, a silica fabric, a basalt fabric, a vermiculite coated glass fabric, an aerogel, or a non-woven glass fabric.

According to still other embodiments, the first barrier layer 102 may be a particular material layer. For example, the first barrier layer 102 may be a mica layer. According to still other embodiments, the first barrier layer 102 may be a mica-fiber glass composite layer. According to yet other embodiments, the first barrier layer 102 may be a glass fabric layer. According to other embodiments, the first barrier layer 102 may be a silica fabric layer. According to still other embodiments, the first barrier layer 102 may be a basalt fabric layer. According to yet other embodiments, the first barrier layer 102 may be a vermiculite coated glass fabric layer. According to other embodiments, the first barrier layer 102 may be an aerogel layer. According to yet other embodiments, the first barrier layer 102 may be a non-woven glass fabric layer. According to still other embodiments, the first barrier layer 102 may be a layer of any combination of mica, a mica-fiber glass composite, a glass fabric, a silica fabric, a basalt fabric, a vermiculite coated glass fabric, an aerogel, or a non-woven glass fabric. According to yet other embodiments, the first barrier layer 102 may be a layer of any lamination of mica, a mica-fiber glass composite, a glass fabric, a silica fabric, a basalt fabric, a vermiculite coated glass fabric, an aerogel, or a non-woven glass fabric.

According to yet other embodiments, the first barrier layer 102 may have a particular thickness. For example, the first barrier layer 102 may have a thickness of at least about 0.05 mm, such as, at least about 0.1 mm or at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.1 mm or at least about 1.2 mm or at least about 1.3 mm or even at least about 1.4 mm. According to still other embodiments, the first barrier layer 102 may have a thickness of not greater than about 7 mm, such as, not greater than about 6.5 mm or not greater than about 6.0 mm or not greater than about 5.5 mm or not greater than about 5.0 mm or not greater than about 4.5 mm or not greater than about 4.0 mm or not greater than about 3.5 mm or not greater than about 3.0 mm or not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or even not greater than about 2.2 mm. It will be appreciated that the thickness of the first barrier layer 102 may be within a range between any of the minimum and maximum values noted above. It will be further appreciated that the thickness of the first barrier layer 102 may be any value between any of the minimum and maximum values noted above.

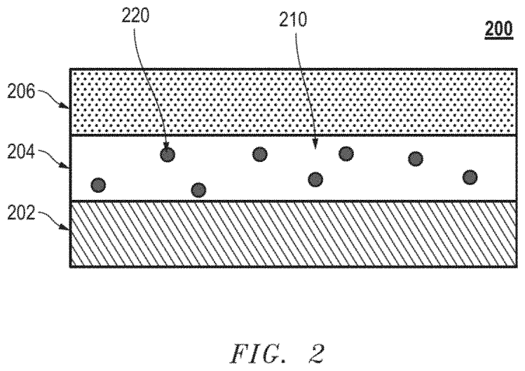

FIG. 2 shows another multilayer composite 200 according to embodiments described herein. As shown in FIG. 2, the multilayer composite 200 may include a first barrier layer 202, a first foam layer 204, and a second barrier layer 206. The first foam layer 204 may include a polyurethane-based matrix component 210, and a flame retardant filler component 220.

It will be appreciated that the multilayer composite 200 and all components described in reference to the multilayer composite 200 as shown in FIG. 2 may have any of the characteristics described herein with reference to corresponding components in FIG. 1. In particular, the characteristics of the multilayer composite 200, the first barrier layer 202, the first foam layer 204, the polyurethane-based matrix component 210, and the flame retardant filler component 220 shown in FIG. 2 may have any of the corresponding characteristics described herein in reference to multilayer composite 100, the first barrier layer 102, the first foam layer 104, the polyurethane-based matrix component 110, and the flame retardant filler component 120 shown in FIG. 1, respectively.

According to still other embodiments, the second barrier layer 206 may be a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

According to still other embodiments, the second barrier layer 206 may include a particular material. For example, the second barrier layer 206 may include mica. According to still other embodiments, the second barrier layer 206 may include a mica-fiber glass composite. According to yet other embodiments, the second barrier layer 206 may include a glass fabric. According to other embodiments, the second barrier layer 206 may include a silica fabric. According to still other embodiments, the second barrier layer 206 may include a basalt fabric. According to yet other embodiments, the second barrier layer 206 may include a vermiculite coated glass fabric. According to other embodiments, the second barrier layer 206 may include an aerogel. According to yet other embodiments, the second barrier layer 206 may include a non-woven glass fabric. According to still other embodiments, the second barrier layer 206 may include any combination of mica, a mica-fiber glass composite, a glass fabric, a silica fabric, a basalt fabric, a vermiculite coated glass fabric, an aerogel, or a non-woven glass fabric. According to yet other embodiments, the second barrier layer 206 may include any lamination of mica, a mica-fiber glass composite, a glass fabric, a silica fabric, a basalt fabric, a vermiculite coated glass fabric, an aerogel, or a non-woven glass fabric.

According to still other embodiments, the second barrier layer 206 may consist of a particular material. For example, the second barrier layer 206 may consist of mica. According to still other embodiments, the second barrier layer 206 may consist of a mica-fiber glass composite. According to yet other embodiments, the second barrier layer 206 may consist of a glass fabric. According to other embodiments, the second barrier layer 206 may consist of a silica fabric. According to still other embodiments, the second barrier layer 206 may consist of a basalt fabric. According to yet other embodiments, the second barrier layer 206 may consist of a vermiculite coated glass fabric. According to other embodiments, the second barrier layer 206 may consist of an aerogel. According to yet other embodiments, the second barrier layer 206 may consist of a non-woven glass fabric. According to still other embodiments, the second barrier layer 206 may consist of any combination of mica, a mica-fiber glass composite, a glass fabric, a silica fabric, a basalt fabric, a vermiculite coated glass fabric, an aerogel, or a non-woven glass fabric. According to yet other embodiments, the second barrier layer 206 may consist of any lamination of mica, a mica-fiber glass composite, a glass fabric, a silica fabric, a basalt fabric, a vermiculite coated glass fabric, an aerogel, or a non-woven glass fabric.

According to still other embodiments, the second barrier layer 206 may be a particular material layer. For example, the second barrier layer 206 may be a mica layer. According to still other embodiments, the second barrier layer 206 may be a mica-fiber glass composite layer. According to yet other embodiments, the second barrier layer 206 may be a glass fabric layer. According to other embodiments, the second barrier layer 206 may be a silica fabric layer. According to still other embodiments, the second barrier layer 206 may be a basalt fabric layer. According to yet other embodiments, the second barrier layer 206 may be a vermiculite coated glass fabric layer. According to other embodiments, the second barrier layer 206 may be an aerogel layer. According to yet other embodiments, the second barrier layer 206 may be a non-woven glass fabric layer. According to still other embodiments, the second barrier layer 206 may be a layer of any combination of mica, a mica-fiber glass composite, a glass fabric, a silica fabric, a basalt fabric, a vermiculite coated glass fabric, an aerogel, or a non-woven glass fabric. According to yet other embodiments, the second barrier layer 206 may be a layer of any lamination of mica, a mica-fiber glass composite, a glass fabric, a silica fabric, a basalt fabric, a vermiculite coated glass fabric, an aerogel, or a non-woven glass fabric.

According to yet other embodiments, the second barrier layer 206 may have a particular thickness. For example, the second barrier layer 206 may have a thickness of at least about 0.05 mm, such as, at least about 0.1 mm or at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.1 mm or at least about 1.2 mm or at least about 1.3 mm or even at least about 1.4 mm. According to still other embodiments, the second barrier layer 206 may have a thickness of not greater than about 7 mm, such as, not greater than about 6.5 mm or not greater than about 6.0 mm or not greater than about 5.5 mm or not greater than about 5.0 mm or not greater than about 4.5 mm or not greater than about 4.0 mm or not greater than about 3.5 mm or not greater than about 3.0 mm or not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or even not greater than about 2.2 mm. It will be appreciated that the thickness of the second barrier layer 206 may be within a range between any of the minimum and maximum values noted above. It will be further appreciated that the thickness of the second barrier layer 206 may be any value between any of the minimum and maximum values noted above.

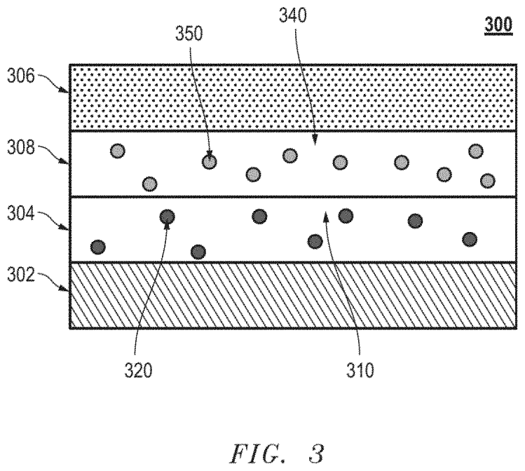

FIG. 3 shows another multilayer composite 300 according to embodiments described herein. As shown in FIG. 3, the multilayer composite 300 may include a first barrier layer 302, a first foam layer 304, a second foam layer 308, and a second barrier layer 306. The first foam layer 304 may include a polyurethane-based matrix component 310, and a flame retardant filler component 320. The second foam layer 308 may include a polyurethane-based matrix component 340, and a flame retardant filler component 350. As shown in FIG. 3, the first foam layer 304 and the second foam layer 308 are both between the first barrier layer 302 and the second barrier layer 306.

It will be appreciated that the multilayer composite 300 and all components described in reference to the multilayer composite 200 as shown in FIG. 2 may have any of the characteristics described herein with reference to corresponding components in FIG. 1 and/or FIG. 2. In particular, the characteristics of the multilayer composite 300, the first barrier layer 302, the first foam layer 304, the second barrier layer 306, the polyurethane-based matrix component 310, and the flame retardant filler component 320 shown in FIG. 3 may have any of the corresponding characteristics described herein in reference to multilayer composite 100 (200), the first barrier layer 102 (202), the first foam layer 104 (204), the polyurethane-based matrix component 110 (210), and the flame retardant filler component 120 (220) shown in FIG. 1 (FIG. 2), respectively.

According to particular embodiments, the polyurethane-based matrix component 340 of the second foam layer 308 may include a particular material. For example, the polyurethane-based matrix component 340 of the second foam layer 308 may include a flexible polyurethane reacted from isocyanate and polyol.

According to particular embodiments, the polyurethane-based matrix component 340 of the second foam layer 308 may consist of a particular material. For example, the polyurethane-based matrix component 340 of the second foam layer 308 may consist of a flexible polyurethane reacted from isocyanate and polyol.

According to particular embodiments, the polyurethane-based matrix component 340 of the second foam layer 308 may be a layer of a particular material. For example, the polyurethane-based matrix component 340 of the second foam layer 308 may be a flexible polyurethane layer, which is reacted from isocyanate and polyol.

According to yet other embodiments, the flame retardant filler component 350 may be selected from a particular group of materials. For example, the flame retardant filler component 350 may be a filler selected from the group consisting of reactive charring agents, mineral compounds, endothermic decomposition compounds, and any combination thereof.

According to still other embodiments, the flame retardant filler component 350 may include a particular material. For example, the flame retardant filler component 350 may include reactive charring agents. It will again be appreciated that a reactive charring agent may be defined as a compound that can react with a carbon source, such as a polymer material, at high temperatures to form a carbon layer. According to still other embodiments, the flame retardant filler component 350 may include melamine. According to yet other embodiments, the flame retardant filler component 350 may include organic phosphorous compounds. According to still other embodiments, the flame retardant filler component 350 may include inorganic phosphorous compounds. According to yet other embodiments, the flame retardant filler component 350 may include metal salts. According to yet other embodiments, the flame retardant filler component 350 may include mineral compounds. According to still other embodiments, the flame retardant filler component 350 may include endothermic decomposition compounds. According to other embodiments, the flame retardant filler component 350 may include any combination of reactive charring agents, melamine, organic phosphorous compounds, inorganic phosphorous compounds, metal salts, mineral compounds, or endothermic decomposition compounds.

According to still other embodiments, the flame retardant filler component 350 may consist of a particular material. For example, the flame retardant filler component 350 may consist of reactive charring agents. According to still other embodiments, the flame retardant filler component 350 may consist of melamine. According to yet other embodiments, the flame retardant filler component 350 may consist of organic phosphorous compounds. According to still other embodiments, the flame retardant filler component 350 may consist of inorganic phosphorous compounds. According to yet other embodiments, the flame retardant filler component 350 may consist of metal salts. According to yet other embodiments, the flame retardant filler component 350 may consist of mineral compounds. According to still other embodiments, the flame retardant filler component 350 may consist of endothermic decomposition compounds. According to other embodiments, the flame retardant filler component 350 may consist of any combination of reactive charring agents, melamine, organic phosphorous compounds, inorganic phosphorous compounds, metal salts, mineral compounds, or endothermic decomposition compounds.

According to still other embodiments, the flame retardant filler component 350 may be a filler of a particular material. For example, the flame retardant filler component 350 may be a filler of reactive charring agents. According to still other embodiments, the flame retardant filler component 350 may be a filler of melamine. According to yet other embodiments, the flame retardant filler component 350 may be a filler of organic phosphorous compounds. According to still other embodiments, the flame retardant filler component 350 may be a filler of inorganic phosphorous compounds. According to yet other embodiments, the flame retardant filler component 350 may be a filler of metal salts. According to yet other embodiments, the flame retardant filler component 350 may be a filler of mineral compounds. According to still other embodiments, the flame retardant filler component 350 may be a filler of endothermic decomposition compounds. According to other embodiments, the flame retardant filler component 350 may be a filler of any combination of reactive charring agents, melamine, organic phosphorous compounds, inorganic phosphorous compounds, metal salts, mineral compounds, or endothermic decomposition compounds.

According to yet other embodiments, the flame retardant filler component 350 may include a particular organic phosphorous compound or inorganic phosphorous compound. For example, the flame retardant filler component 350 may include a phosphate. According to yet other embodiments, the flame retardant filler component 350 may include a phosphonate. According to yet other embodiments, the flame retardant filler component 350 may include a phosphinate. According to a particular embodiment, the flame retardant filler component 350 may include any combination of a phosphate, a phosphonate, or a phosphinate.

According to yet other embodiments, the flame retardant filler component 350 may consist of a particular organic phosphorous compound or inorganic phosphorous compound. For example, the flame retardant filler component 350 may consist of a phosphate. According to yet other embodiments, the flame retardant filler component 350 may consist of a phosphonate. According to yet other embodiments, the flame retardant filler component 350 may consist of a phosphinate. According to a particular embodiment, the flame retardant filler component 350 may consist of any combination of a phosphate, a phosphonate, or a phosphinate.

According to yet other embodiments, the flame retardant filler component 350 may be a filler of a particular organic phosphorous compound or inorganic phosphorous compound. For example, the flame retardant filler component 350 may be a filler of a phosphate. According to yet other embodiments, the flame retardant filler component 350 may be a filler of a phosphonate. According to yet other embodiments, the flame retardant filler component 350 may be a filler of a phosphinate. According to a particular embodiment, the flame retardant filler component 350 may be a filler of any combination of a phosphate, a phosphonate, or a phosphinate.

According to still other embodiments, the flame retardant filler component 350 may include a particular metal salt. For example, the flame retardant filler component 350 may include aluminum diethyl phosphinate.

According to still other embodiments, the flame retardant filler component 350 may consist of a particular metal salt. For example, the flame retardant filler component 350 may consist of aluminum diethyl phosphinate.

According to still other embodiments, the flame retardant filler component 350 may be a filler of a particular metal salt. For example, the flame retardant filler component 350 may be a filler of aluminum diethyl phosphinate. According to still other embodiments, the flame retardant filler component 350 may include a particular mineral compound. For example, the flame retardant filler component 350 may include expandable graphite.

According to still other embodiments, the flame retardant filler component 350 may consist of a particular mineral compound. For example, the flame retardant filler component 350 may consist of expandable graphite.

According to still other embodiments, the flame retardant filler component 350 may be a filler of a particular mineral compound. For example, the flame retardant filler component 350 may be an expandable graphite filler.

According to yet other embodiments, the flame retardant filler component 350 may include a particular endothermic decomposition compound. For example, the flame retardant filler component 350 may include a metal hydrate. According to still other embodiments, the flame retardant filler component 350 may include a metal silicate. According to yet other embodiments, the flame retardant filler component 350 may include a carbonate. According to a particular embodiment, the flame retardant filler component 350 may include aluminum trihydrate. According to still other embodiments, the flame retardant filler component 350 may include zinc borate. According to yet other embodiments, the flame retardant filler component 350 may include any combination of a metal hydrate, a metal silicate, a carbonate, aluminum trihydrate, or zinc borate.

According to yet other embodiments, the flame retardant filler component 350 may consist of a particular endothermic decomposition compound. For example, the flame retardant filler component 350 may consist of a metal hydrate. According to still other embodiments, the flame retardant filler component 350 may consist of a metal silicate. According to yet other embodiments, the flame retardant filler component 350 may consist of a carbonate. According to a particular embodiment, the flame retardant filler component 350 may consist of aluminum trihydrate. According to still other embodiments, the flame retardant filler component 350 may consist of zinc borate. According to yet other embodiments, the flame retardant filler component 350 may consist of any combination of a metal hydrate, a metal silicate, a carbonate, aluminum trihydrate, or zinc borate.

According to yet other embodiments, the flame retardant filler component 350 may be a filler of a particular endothermic decomposition compound. For example, the flame retardant filler component 350 may be a metal hydrate filler. According to still other embodiments, the flame retardant filler component 350 may be a metal silicate filler. According to yet other embodiments, the flame retardant filler component 350 may be a carbonate filler. According to a particular embodiment, the flame retardant filler component 350 may be an aluminum trihydrate filler. According to still other embodiments, the flame retardant filler component 350 may be a filler of zinc borate. According to yet other embodiments, the flame retardant filler component 350 may be a filler of any combination of a metal hydrate, a metal silicate, a carbonate, aluminum trihydrate, or zinc borate.

According to certain embodiments, the second foam layer 308 may include a particular content of the polyurethane-based matrix component 340. For example, the second foam layer 308 may include a polyurethane-based matrix component content of at least about 40 wt. % for a total weight of the second foam layer 308, such as, at least about 45 wt. % or at least about 50 wt. % or at least about 55 wt. % or at least about 60 wt. % or at least about 65 wt. % or even at least about 70 wt. %. According to yet other embodiments, the second foam layer 308 may include a polyurethane-based matrix component content of not greater than about 95 wt. % for a total weight of the second foam layer 308, such as, not greater than about 90 wt. % or not greater than about 85 wt. % or not greater than about 80 wt. % or even not greater than about 75 wt. %. It will be appreciated that the polyurethane-based matrix component content of the second foam layer 308 may be within a range between any of the values noted above. It will be further appreciated that the polyurethane-based matrix component content of the second foam layer 308 may be any value between any of the minimum and maximum values noted above.

According to still other embodiments, the second foam layer 308 may include a particular content of flame retardant filler component 350. For example, the second foam layer 308 may include a flame retardant filler component content of at least about 5 wt. % for a total weight of the second foam layer 308, such as, at least about 10 wt. % or at least about 15 wt. % or at least about 20 wt. % or at least about 25 wt. % or at least about 30 wt. % or even at least about 35 wt. %. According to yet other embodiments, the second foam layer 308 may include a flame retardant filler component content of not greater than about 60 wt. % for a total weight of the second foam layer 308, such as, not greater than about 55 wt. % or not greater than about 50 wt. % or not greater than about 45 wt. % or even not greater than about 40 wt. %. It will be appreciated that the flame retardant filler component content of the second foam layer 308 may be within a range between any of the values noted above. It will be further appreciated that the flame retardant filler component content of the second foam layer 308 may be any value between any of the minimum and maximum values noted above.

According to certain embodiments, the second foam layer 308 may have a particular flammability rating as measured according to ASTM D4986. In particular, the foam layer may have a HBF flammability rating as measured according to ASTM D4986.

According to certain embodiments, the second foam layer 308 may have a particular flammability rating as measured according to ASTM D3801. In particular, the foam layer may have a V-0 flammability rating as measured according to ASTM D3801.

According to still other embodiments, the second foam layer 308 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the second foam layer 308 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the second foam layer 308 may have a cold side temperature of at least about 25° C. It will be appreciated that the cold side temperature of the second foam layer 308 may be within a range between any of the values noted above. It will be further appreciated that the cold side temperature of the second foam layer 308 may be any value between any of the values noted above.

According to yet other embodiments, the second foam layer 308 may have a particular thickness. For example, the second foam layer 308 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the second foam layer 308 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the second foam layer 308 may be within a range between any of the minimum and maximum values noted above. It will be further appreciated that the thickness of the second foam layer 308 may be any value between any of the minimum and maximum values noted above.

According to yet other embodiments, the second foam layer 308 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the second foam layer 308 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the second foam layer 308 may have a 25% strain compression rating of at least about 5 kPa, such as, at least about 10 kPa or at least about 15 kPa or at least about 20 kPa or at least about 25 kPa. It will be appreciated that the 25% strain compression rating of the second foam layer 308 may be within a range between any of the minimum and maximum values noted above. It will be further appreciated that the 50% strain compression rating of the second foam layer 308 may be any value between any of the minimum and maximum values noted above.

According to yet other embodiments, the second foam layer 308 may have a particular density. For the purpose of embodiments described herein, the density of the second foam layer 308 may be determined according to ASTM D1056. According to certain embodiments, the second foam layer 308 may have a density of not greater than about 600 kg/m³, such as, not great than about 575 kg/m³ or not greater than about 550 kg/m³ or not greater than about 525 kg/m³ or not greater than about 500 kg/m³ or not greater than about 450 kg/m³ or not greater than about 400 kg/m³ or not greater than about 350 kg/m³ or even not greater than about 300 kg/m³. According to yet other embodiments, the second foam layer 308 may have a density of at least about 50 kg/m³, such as, at least about 60 kg/m³ or at least about 80 kg/m³ or at least about 100 kg/m³ or at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the second foam layer 308 may be within a range between any of the minimum and maximum values noted above. It will be further appreciated that the density of the second foam layer 308 may be any value between any of the minimum and maximum values noted above.

According to yet other embodiments, the second foam layer 308 may have a particular thermal conductivity as measured according to ASTM C518. For example, the second foam layer 308 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the second foam layer 308 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the second foam layer 308 may be within a range between any of the minimum and maximum values noted above. It will be further appreciated that the thermal conductivity of the second foam layer 308 may be any value between any of the minimum and maximum values noted above.

According to certain embodiments, the foam layer described herein may be formed according to any acceptable forming process for a foam material or foam layer.

Tuning now to additional embodiments described herein, such embodiments are generally directed to a thermal barrier composite that may include a first barrier layer and a first foam layer. According to particular embodiments, the first foam layer may include a polyurethane-based matrix component, and a flame retardant filler component. According to still other embodiments, the thermal barrier composite may demonstrate a combination of improved performance in flame resistance and compression.

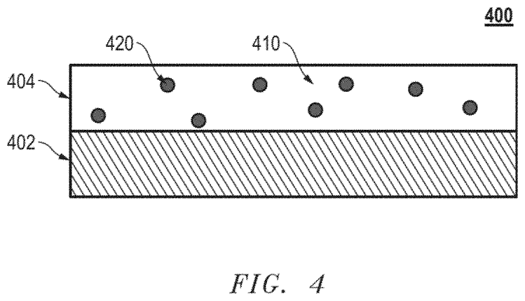

For purposes of illustration, FIG. 4 shows a thermal barrier composite 400 according to embodiments described herein. As shown in FIG. 4, a thermal barrier composite 400 may include a first barrier layer 402 and a first foam layer 404. The first foam layer 404 may include a polyurethane-based matrix component 410, and a flame retardant filler component 420.

According to particular embodiments, the polyurethane-based matrix component 410 of the first foam layer 404 may include a particular material. For example, the polyurethane-based matrix component 410 of the first foam layer 404 may include a flexible polyurethane reacted from isocyanate and polyol.

According to particular embodiments, the polyurethane-based matrix component 410 of the first foam layer 404 may consist of a particular material. For example, the polyurethane-based matrix component 410 of the first foam layer 404 may consist of a flexible polyurethane reacted from isocyanate and polyol.

According to particular embodiments, the polyurethane-based matrix component 410 of the first foam layer 404 may be a layer of a particular material. For example, the polyurethane-based matrix component 410 of the first foam layer 404 may be a flexible polyurethane layer, which is reacted from isocyanate and polyol.

According to yet other embodiments, the flame retardant filler component 420 may be selected from a particular group of materials. For example, the flame retardant filler component 420 may be a filler selected from the group consisting of reactive charring agents, mineral compounds, endothermic decomposition compounds, and any combination thereof.

According to still other embodiments, the flame retardant filler component 420 may include a particular material. For example, the flame retardant filler component 420 may include reactive charring agents. It will again be appreciated that a reactive charring agent may be defined as a compound that can react with a carbon source, such as a polymer material, at high temperatures to form a carbon layer. According to still other embodiments, the flame retardant filler component 420 may include melamine. According to yet other embodiments, the flame retardant filler component 420 may include organic phosphorous compounds. According to still other embodiments, the flame retardant filler component 420 may include inorganic phosphorous compounds. According to yet other embodiments, the flame retardant filler component 420 may include metal salts. According to yet other embodiments, the flame retardant filler component 420 may include mineral compounds. According to still other embodiments, the flame retardant filler component 420 may include endothermic decomposition compounds. According to other embodiments, the flame retardant filler component 420 may include any combination of reactive charring agents, melamine, organic phosphorous compounds, inorganic phosphorous compounds, metal salts, mineral compounds, or endothermic decomposition compounds.

According to still other embodiments, the flame retardant filler component 420 may consist of a particular material. For example, the flame retardant filler component 420 may consist of reactive charring agents. According to still other embodiments, the flame retardant filler component 420 may consist of melamine. According to yet other embodiments, the flame retardant filler component 420 may consist of organic phosphorous compounds. According to still other embodiments, the flame retardant filler component 420 may consist of inorganic phosphorous compounds. According to yet other embodiments, the flame retardant filler component 420 may consist of metal salts. According to yet other embodiments, the flame retardant filler component 420 may consist of mineral compounds. According to still other embodiments, the flame retardant filler component 420 may consist of endothermic decomposition compounds. According to other embodiments, the flame retardant filler component 420 may consist of any combination of reactive charring agents, melamine, organic phosphorous compounds, inorganic phosphorous compounds, metal salts, mineral compounds, or endothermic decomposition compounds.

According to still other embodiments, the flame retardant filler component 420 may be a filler of a particular material. For example, the flame retardant filler component 420 may be a filler of reactive charring agents. According to still other embodiments, the flame retardant filler component 420 may be a filler of melamine. According to yet other embodiments, the flame retardant filler component 420 may be a filler of organic phosphorous compounds. According to still other embodiments, the flame retardant filler component 420 may be a filler of inorganic phosphorous compounds. According to yet other embodiments, the flame retardant filler component 420 may be a filler of metal salts. According to yet other embodiments, the flame retardant filler component 420 may be a filler of mineral compounds. According to still other embodiments, the flame retardant filler component 420 may be a filler of endothermic decomposition compounds. According to other embodiments, the flame retardant filler component 420 may be a filler of any combination of reactive charring agents, melamine, organic phosphorous compounds, inorganic phosphorous compounds, metal salts, mineral compounds, or endothermic decomposition compounds.

According to yet other embodiments, the flame retardant filler component 420 may include a particular organic phosphorous compound or inorganic phosphorous compound. For example, the flame retardant filler component 420 may include a phosphate. According to yet other embodiments, the flame retardant filler component 420 may include a phosphonate. According to yet other embodiments, the flame retardant filler component 420 may include a phosphinate. According to a particular embodiment, the flame retardant filler component 420 may include any combination of a phosphate, a phosphonate, or a phosphinate.

According to yet other embodiments, the flame retardant filler component 420 may consist of a particular organic phosphorous compound or inorganic phosphorous compound. For example, the flame retardant filler component 420 may consist of a phosphate. According to yet other embodiments, the flame retardant filler component 420 may consist of a phosphonate. According to yet other embodiments, the flame retardant filler component 420 may consist of a phosphinate. According to a particular embodiment, the flame retardant filler component 420 may consist of any combination of a phosphate, a phosphonate, or a phosphinate.

According to yet other embodiments, the flame retardant filler component 420 may be a filler of a particular organic phosphorous compound or inorganic phosphorous compound. For example, the flame retardant filler component 420 may be a filler of a phosphate. According to yet other embodiments, the flame retardant filler component 420 may be a filler of a phosphonate. According to yet other embodiments, the flame retardant filler component 420 may be a filler of a phosphinate. According to a particular embodiment, the flame retardant filler component 420 may be a filler of any combination of a phosphate, a phosphonate, or a phosphinate.

According to still other embodiments, the flame retardant filler component 420 may include a particular metal salt. For example, the flame retardant filler component 420 may include aluminum diethyl phosphinate.

According to still other embodiments, the flame retardant filler component 420 may consist of a particular metal salt. For example, the flame retardant filler component 420 may consist of aluminum diethyl phosphinate.

According to still other embodiments, the flame retardant filler component 420 may be a filler of a particular metal salt. For example, the flame retardant filler component 420 may be a filler of aluminum diethyl phosphinate. According to still other embodiments, the flame retardant filler component 420 may include a particular mineral compound. For example, the flame retardant filler component 420 may include expandable graphite.

According to still other embodiments, the flame retardant filler component 420 may consist of a particular mineral compound. For example, the flame retardant filler component 420 may consist of expandable graphite.

According to still other embodiments, the flame retardant filler component 420 may be a filler of a particular mineral compound. For example, the flame retardant filler component 420 may be an expandable graphite filler.

According to yet other embodiments, the flame retardant filler component 420 may include a particular endothermic decomposition compound. For example, the flame retardant filler component 420 may include a metal hydrate. According to still other embodiments, the flame retardant filler component 420 may include a metal silicate. According to yet other embodiments, the flame retardant filler component 420 may include a carbonate. According to a particular embodiment, the flame retardant filler component 420 may include aluminum trihydrate. According to still other embodiments, the flame retardant filler component 420 may include zinc borate. According to yet other embodiments, the flame retardant filler component 420 may include any combination of a metal hydrate, a metal silicate, a carbonate, aluminum trihydrate, or zinc borate.

According to yet other embodiments, the flame retardant filler component 420 may consist of a particular endothermic decomposition compound. For example, the flame retardant filler component 420 may consist of a metal hydrate. According to still other embodiments, the flame retardant filler component 420 may consist of a metal silicate. According to yet other embodiments, the flame retardant filler component 420 may consist of a carbonate. According to a particular embodiment, the flame retardant filler component 420 may consist of aluminum trihydrate. According to still other embodiments, the flame retardant filler component 420 may consist of zinc borate. According to yet other embodiments, the flame retardant filler component 420 may consist of any combination of a metal hydrate, a metal silicate, a carbonate, aluminum trihydrate, or zinc borate.

According to yet other embodiments, the flame retardant filler component 420 may be a filler of a particular endothermic decomposition compound. For example, the flame retardant filler component 420 may be a metal hydrate filler. According to still other embodiments, the flame retardant filler component 420 may be a metal silicate filler. According to yet other embodiments, the flame retardant filler component 420 may be a carbonate filler. According to a particular embodiment, the flame retardant filler component 420 may be an aluminum trihydrate filler. According to still other embodiments, the flame retardant filler component 420 may be a filler of zinc borate. According to yet other embodiments, the flame retardant filler component 420 may be a filler of any combination of a metal hydrate, a metal silicate, a carbonate, aluminum trihydrate, or zinc borate.

According to certain embodiments, the first foam layer 404 may include a particular content of the polyurethane-based matrix component 410. For example, the first foam layer 404 may include a polyurethane-based matrix component content of at least about 40 wt. % for a total weight of the first foam layer 404, such as, at least about 45 wt. % or at least about 50 wt. % or at least about 55 wt. % or at least about 60 wt. % or at least about 65 wt. % or even at least about 70 wt. %. According to yet other embodiments, the first foam layer 404 may include a polyurethane-based matrix component content of not greater than about 95 wt. % for a total weight of the first foam layer 404, such as, not greater than about 90 wt. % or not greater than about 85 wt. % or not greater than about 80 wt. % or even not greater than about 75 wt. %. It will be appreciated that the polyurethane-based matrix component content of the first foam layer 404 may be within a range between any of the values noted above. It will be further appreciated that the polyurethane-based matrix component content of the first foam layer 404 may be any value between any of the minimum and maximum values noted above.

According to still other embodiments, the first foam layer 404 may include a particular content of flame retardant filler component 420. For example, the first foam layer 404 may include a flame retardant filler component content of at least about 5 wt. % for a total weight of the first foam layer 404, such as, at least about 10 wt. % or at least about 15 wt. % or at least about 20 wt. % or at least about 25 wt. % or at least about 30 wt. % or even at least about 35 wt. %. According to yet other embodiments, the first foam layer 404 may include a flame retardant filler component content of not greater than about 60 wt. % for a total weight of the first foam layer 404, such as, not greater than about 55 wt. % or not greater than about 50 wt. % or not greater than about 45 wt. % or even not greater than about 40 wt. %. It will be appreciated that the flame retardant filler component content of the first foam layer 404 may be within a range between any of the minimum and maximum values noted above. It will be further appreciated that the flame retardant filler component content of the first foam layer 404 may be any value between any of the minimum and maximum values noted above.

According to certain embodiments, the first foam layer 404 may have a particular flammability rating as measured according to ASTM D4986. In particular, the foam layer may have a HFB flammability rating as measured according to ASTM D4986.

According to certain embodiments, the thermal barrier composite 400 may have a particular flammability rating as measured according to ASTM D4986. In particular, the foam layer may have a HFB flammability rating as measured according to ASTM D4986.

According to still other embodiments, the first foam layer 404 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the first foam layer 404 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the first foam layer 404 may have a cold side temperature of at least about 25° C. It will be appreciated that the cold side temperature of the first foam layer 404 may be within a range between any of the values noted above. It will be further appreciated that the cold side temperature of the first foam layer 404 may be any value between any of the values noted above.

According to still other embodiments, the thermal barrier composite 400 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the thermal barrier composite 400 may have a cold side temperature of not greater than about 300° C., such as, not greater than about 275° C. or not greater than about 250° C. or not greater than about 225° C. or not greater than about 200° C. or not greater than about 175° C. or even not greater than about 150° C. According to still other embodiments, the thermal barrier composite 400 may have a cold side temperature of at least about 25° C. It will be appreciated that the cold side temperature of the thermal barrier composite 400 may be within a range between any of the values noted above. It will be further appreciated that the cold side temperature of the thermal barrier composite 400 may be any value between any of the values noted above.

According to yet other embodiments, the first foam layer 404 may have a particular thickness. For example, the first foam layer 404 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the first foam layer 404 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the first foam layer 404 may be within a range between any of the minimum and maximum values noted above. It will be further appreciated that the thickness of the first foam layer 404 may be any value between any of the minimum and maximum values noted above.

According to yet other embodiments, the thermal barrier composite 400 may have a particular thickness. For example, the thermal barrier composite 400 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the thermal barrier composite 400 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the thermal barrier composite 400 may be within a range between any of the minimum and maximum values noted above. It will be further appreciated that the thickness of the thermal barrier composite 400 may be any value between any of the minimum and maximum values noted above.

According to yet other embodiments, the first foam layer 404 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the first foam layer 404 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the first foam layer 404 may have a 25% strain compression rating of at least about 5 kPa, such as, at least about 10 kPa or at least about 15 kPa or at least about 20 kPa or at least about 25 kPa. It will be appreciated that the 25% strain compression rating of the first foam layer 404 may be within a range between any of the minimum and maximum values noted above. It will be further appreciated that the 25% strain compression rating of the first foam layer 404 may be any value between any of the minimum and maximum values noted above.

According to yet other embodiments, the thermal barrier composite 400 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the thermal barrier composite 400 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the thermal barrier composite 400 may have a 25% strain compression rating of at least about 5 kPa, such as, at least about 10 kPa or at least about 15 kPa or at least about 20 kPa or at least about 25 kPa. It will be appreciated that the 25% strain compression rating of the thermal barrier composite 400 may be within a range between any of the minimum and maximum values noted above. It will be further appreciated that the 25% strain compression rating of the thermal barrier composite 400 may be any value between any of the minimum and maximum values noted above.

According to yet other embodiments, the first foam layer 404 may have a particular density. For the purpose of embodiments described herein, the density of the first foam layer 404 may be determined according to ASTM D1056. According to certain embodiments, the first foam layer 404 may have a density of not greater than about 600 kg/m³, such as, not great than about 575 kg/m³ or not greater than about 550 kg/m³ or not greater than about 525 kg/m³ or not greater than about 500 kg/m³ or not greater than about 450 kg/m³ or not greater than about 400 kg/m³ or not greater than about 350 kg/m³ or even not greater than about 300 kg/m³. According to yet other embodiments, the first foam layer 404 may have a density of at least about 50 kg/m³, such as, at least about 60 kg/m³ or at least about 80 kg/m³ or at least about 100 kg/m³ or at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the first foam layer 404 may be within a range between any of the minimum and maximum values noted above. It will be further appreciated that the density of the first foam layer 404 may be any value between any of the minimum and maximum values noted above.

According to yet other embodiments, the thermal barrier composite 400 may have a particular density. For the purpose of embodiments described herein, the density of the thermal barrier composite 400 may be determined according to ASTM D1056. According to certain embodiments, the thermal barrier composite 400 may have a density of not greater than about 600 kg/m³, such as, not great than about 575 kg/m³ or not greater than about 550 kg/m³ or not greater than about 525 kg/m³ or not greater than about 500 kg/m³ or not greater than about 450 kg/m³ or not greater than about 400 kg/m³ or not greater than about 350 kg/m³ or even not greater than about 300 kg/m³. According to yet other embodiments, the thermal barrier composite 400 may have a density of at least about 50 kg/m³, such as, at least about 60 kg/m³ or at least about 80 kg/m³ or at least about 100 kg/m³ or at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the thermal barrier composite 400 may be within a range between any of the minimum and maximum values noted above. It will be further appreciated that the density of the thermal barrier composite 400 may be any value between any of the minimum and maximum values noted above.

According to yet other embodiments, the first foam layer 404 may have a particular thermal conductivity as measured according to ASTM C518. For example, the first foam layer 404 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the first foam layer 404 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the first foam layer 404 may be within a range between any of the minimum and maximum values noted above. It will be further appreciated that the thermal conductivity of the first foam layer 404 may be any value between any of the minimum and maximum values noted above.

According to yet other embodiments, the thermal barrier composite 400 may have a particular thermal conductivity as measured according to ASTM C518. For example, the thermal barrier composite 400 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the thermal barrier composite 400 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the thermal barrier composite 400 may be within a range between any of the minimum and maximum values noted above. It will be further appreciated that the thermal conductivity of the thermal barrier composite 400 may be any value between any of the minimum and maximum values noted above.

According to still other embodiments, the first barrier layer 402 may be a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

According to still other embodiments, the first barrier layer 402 may include a particular material. For example, the first barrier layer 402 may include mica. According to still other embodiments, the first barrier layer 402 may include a mica-fiber glass composite. According to yet other embodiments, the first barrier layer 402 may include a glass fabric. According to other embodiments, the first barrier layer 402 may include a silica fabric. According to still other embodiments, the first barrier layer 402 may include a basalt fabric. According to yet other embodiments, the first barrier layer 402 may include a vermiculite coated glass fabric. According to other embodiments, the first barrier layer 402 may include an aerogel. According to yet other embodiments, the first barrier layer 402 may include a non-woven glass fabric. According to still other embodiments, the first barrier layer 402 may include any combination of mica, a mica-fiber glass composite, a glass fabric, a silica fabric, a basalt fabric, a vermiculite coated glass fabric, an aerogel, or a non-woven glass fabric. According to yet other embodiments, the first barrier layer 402 may include any lamination of mica, a mica-fiber glass composite, a glass fabric, a silica fabric, a basalt fabric, a vermiculite coated glass fabric, an aerogel, or a non-woven glass fabric.

According to still other embodiments, the first barrier layer 402 may consist of a particular material. For example, the first barrier layer 402 may consist of mica. According to still other embodiments, the first barrier layer 402 may consist of a mica-fiber glass composite. According to yet other embodiments, the first barrier layer 402 may consist of a glass fabric. According to other embodiments, the first barrier layer 402 may consist of a silica fabric. According to still other embodiments, the first barrier layer 402 may consist of a basalt fabric. According to yet other embodiments, the first barrier layer 402 may consist of a vermiculite coated glass fabric. According to other embodiments, the first barrier layer 402 may consist of an aerogel. According to yet other embodiments, the first barrier layer 402 may consist of a non-woven glass fabric. According to still other embodiments, the first barrier layer 402 may consist of any combination of mica, a mica-fiber glass composite, a glass fabric, a silica fabric, a basalt fabric, a vermiculite coated glass fabric, an aerogel, or a non-woven glass fabric. According to yet other embodiments, the first barrier layer 402 may consist of any lamination of mica, a mica-fiber glass composite, a glass fabric, a silica fabric, a basalt fabric, a vermiculite coated glass fabric, an aerogel, or a non-woven glass fabric.

According to still other embodiments, the first barrier layer 402 may be a particular material layer. For example, the first barrier layer 402 may be a mica layer. According to still other embodiments, the first barrier layer 402 may be a mica-fiber glass composite layer. According to yet other embodiments, the first barrier layer 402 may be a glass fabric layer. According to other embodiments, the first barrier layer 402 may be a silica fabric layer. According to still other embodiments, the first barrier layer 402 may be a basalt fabric layer. According to yet other embodiments, the first barrier layer 402 may be a vermiculite coated glass fabric layer. According to other embodiments, the first barrier layer 402 may be an aerogel layer. According to yet other embodiments, the first barrier layer 402 may be a non-woven glass fabric layer. According to still other embodiments, the first barrier layer 402 may be a layer of any combination of mica, a mica-fiber glass composite, a glass fabric, a silica fabric, a basalt fabric, a vermiculite coated glass fabric, an aerogel, or a non-woven glass fabric. According to yet other embodiments, the first barrier layer 402 may be a layer of any lamination of mica, a mica-fiber glass composite, a glass fabric, a silica fabric, a basalt fabric, a vermiculite coated glass fabric, an aerogel, or a non-woven glass fabric.

According to yet other embodiments, the first barrier layer 402 may have a particular thickness. For example, the first barrier layer 402 may have a thickness of at least about 0.05 mm, such as, at least about 0.1 mm or at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.1 mm or at least about 1.2 mm or at least about 1.3 mm or even at least about 1.4 mm. According to still other embodiments, the first barrier layer 402 may have a thickness of not greater than about 7 mm, such as, not greater than about 6.5 mm or not greater than about 6.0 mm or not greater than about 5.5 mm or not greater than about 5.0 mm or not greater than about 4.5 mm or not greater than about 4.0 mm or not greater than about 3.5 mm or not greater than about 3.0 mm or not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or even not greater than about 2.2 mm. It will be appreciated that the thickness of the first barrier layer 402 may be within a range between any of the minimum and maximum values noted above. It will be further appreciated that the thickness of the first barrier layer 402 may be any value between any of the minimum and maximum values noted above.

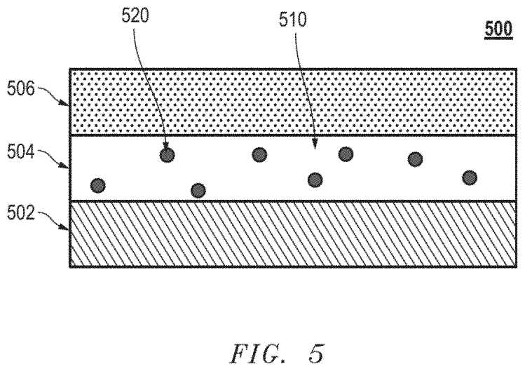

FIG. 5 shows another thermal barrier composite 500 according to embodiments described herein. As shown in FIG. 5, the thermal barrier composite 500 may include a first barrier layer 502, a first foam layer 504, and a second barrier layer 506. The first foam layer 504 may include a polyurethane-based matrix component 510, and a flame retardant filler component 520.

It will be appreciated that the thermal barrier composite 500 and all components described in reference to the thermal barrier composite 500 as shown in FIG. 5 may have any of the characteristics described herein with reference to corresponding components in FIG. 4. In particular, the characteristics of the thermal barrier composite 500, the first barrier layer 502, the first foam layer 504, the polyurethane-based matrix component 510, and the flame retardant filler component 520 shown in FIG. 5 may have any of the corresponding characteristics described herein in reference to thermal barrier composite 400, the first barrier layer 402, the first foam layer 404, the polyurethane-based matrix component 410, and the flame retardant filler component 420 shown in FIG. 4, respectively.

According to still other embodiments, the second barrier layer 506 may be a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

According to still other embodiments, the second barrier layer 506 may include a particular material. For example, the second barrier layer 506 may include mica. According to still other embodiments, the second barrier layer 506 may include a mica-fiber glass composite. According to yet other embodiments, the second barrier layer 506 may include a glass fabric. According to other embodiments, the second barrier layer 506 may include a silica fabric. According to still other embodiments, the second barrier layer 506 may include a basalt fabric. According to yet other embodiments, the second barrier layer 506 may include a vermiculite coated glass fabric. According to other embodiments, the second barrier layer 506 may include an aerogel. According to yet other embodiments, the second barrier layer 506 may include a non-woven glass fabric. According to still other embodiments, the second barrier layer 506 may include any combination of mica, a mica-fiber glass composite, a glass fabric, a silica fabric, a basalt fabric, a vermiculite coated glass fabric, an aerogel, or a non-woven glass fabric. According to yet other embodiments, the second barrier layer 506 may include any lamination of mica, a mica-fiber glass composite, a glass fabric, a silica fabric, a basalt fabric, a vermiculite coated glass fabric, an aerogel, or a non-woven glass fabric.

According to still other embodiments, the second barrier layer 506 may consist of a particular material. For example, the second barrier layer 506 may consist of mica. According to still other embodiments, the second barrier layer 506 may consist of a mica-fiber glass composite. According to yet other embodiments, the second barrier layer 506 may consist of a glass fabric. According to other embodiments, the second barrier layer 506 may consist of a silica fabric. According to still other embodiments, the second barrier layer 506 may consist of a basalt fabric. According to yet other embodiments, the second barrier layer 506 may consist of a vermiculite coated glass fabric. According to other embodiments, the second barrier layer 506 may consist of an aerogel. According to yet other embodiments, the second barrier layer 506 may consist of a non-woven glass fabric. According to still other embodiments, the second barrier layer 506 may consist of any combination of mica, a mica-fiber glass composite, a glass fabric, a silica fabric, a basalt fabric, a vermiculite coated glass fabric, an aerogel, or a non-woven glass fabric. According to yet other embodiments, the second barrier layer 506 may consist of any lamination of mica, a mica-fiber glass composite, a glass fabric, a silica fabric, a basalt fabric, a vermiculite coated glass fabric, an aerogel, or a non-woven glass fabric.

According to still other embodiments, the second barrier layer 506 may be a particular material layer. For example, the second barrier layer 506 may be a mica layer. According to still other embodiments, the second barrier layer 506 may be a mica-fiber glass composite layer. According to yet other embodiments, the second barrier layer 506 may be a glass fabric layer. According to other embodiments, the second barrier layer 506 may be a silica fabric layer. According to still other embodiments, the second barrier layer 506 may be a basalt fabric layer. According to yet other embodiments, the second barrier layer 506 may be a vermiculite coated glass fabric layer. According to other embodiments, the second barrier layer 506 may be an aerogel layer. According to yet other embodiments, the second barrier layer 506 may be a non-woven glass fabric layer. According to still other embodiments, the second barrier layer 506 may be a layer of any combination of mica, a mica-fiber glass composite, a glass fabric, a silica fabric, a basalt fabric, a vermiculite coated glass fabric, an aerogel, or a non-woven glass fabric. According to yet other embodiments, the second barrier layer 506 may be a layer of any lamination of mica, a mica-fiber glass composite, a glass fabric, a silica fabric, a basalt fabric, a vermiculite coated glass fabric, an aerogel, or a non-woven glass fabric.

According to yet other embodiments, the second barrier layer 506 may have a particular thickness. For example, the second barrier layer 506 may have a thickness of at least about 0.05 mm, such as, at least about 0.1 mm or at least about 0.2 mm or at least about 0.3 mm or at least about 0.4 mm or at least about 0.5 mm or at least about 0.6 mm or at least about 0.7 mm or at least about 0.8 mm or at least about 0.9 mm or at least about 1.0 mm or at least about 1.1 mm or at least about 1.2 mm or at least about 1.3 mm or even at least about 1.4 mm. According to still other embodiments, the second barrier layer 506 may have a thickness of not greater than about 7 mm, such as, not greater than about 6.5 mm or not greater than about 6.0 mm or not greater than about 5.5 mm or not greater than about 5.0 mm or not greater than about 4.5 mm or not greater than about 4.0 mm or not greater than about 3.5 mm or not greater than about 3.0 mm or not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or even not greater than about 2.2 mm. It will be appreciated that the thickness of the second barrier layer 506 may be within a range between any of the minimum and maximum values noted above. It will be further appreciated that the thickness of the second barrier layer 506 may be any value between any of the minimum and maximum values noted above.

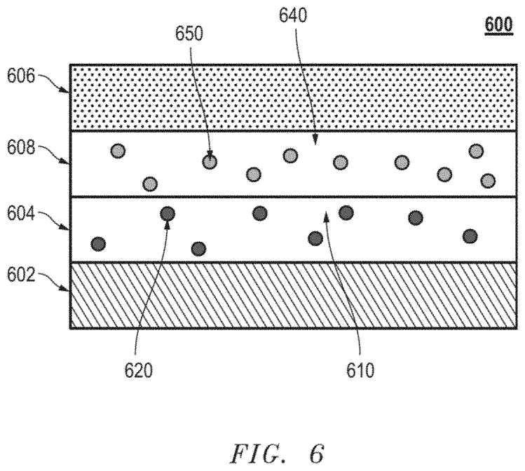

FIG. 6 shows another thermal barrier composite 600 according to embodiments described herein. As shown in FIG. 6, the thermal barrier composite 600 may include a first barrier layer 602, a first foam layer 604, a second foam layer 608, and a second barrier layer 606. The first foam layer 604 may include a polyurethane-based matrix component 610, and a flame retardant filler component 620. The second foam layer 608 may include a polyurethane-based matrix component 640, and a flame retardant filler component 650. As shown in FIG. 6, the first foam layer 604 and the second foam layer 608 are both between the first barrier layer 602 and the second barrier layer 606.

It will be appreciated that the thermal barrier composite 600 and all components described in reference to the thermal barrier composite 600 as shown in FIG. 6 may have any of the characteristics described herein with reference to corresponding components in FIG. 4 and/or FIG. 5. In particular, the characteristics of the thermal barrier composite 600, the first barrier layer 602, the first foam layer 604, the second barrier layer 606, the polyurethane-based matrix component 610, and the flame retardant filler component 620 shown in FIG. 6 may have any of the corresponding characteristics described herein in reference to thermal barrier composite 400 (500), the first barrier layer 402 (502), the first foam layer 404 (504), the polyurethane-based matrix component 410 (510), and the flame retardant filler component 420 (520) shown in FIG. 4 (FIG. 5), respectively.

According to particular embodiments, the polyurethane-based matrix component 640 of the second foam layer 608 may include a particular material. For example, the polyurethane-based matrix component 640 of the second foam layer 608 may include a flexible polyurethane reacted from isocyanate and polyol.

According to particular embodiments, the polyurethane-based matrix component 640 of the second foam layer 608 may consist of a particular material. For example, the polyurethane-based matrix component 640 of the second foam layer 608 may consist of a flexible polyurethane reacted from isocyanate and polyol.

According to particular embodiments, the polyurethane-based matrix component 640 of the second foam layer 608 may be a layer of a particular material. For example, the polyurethane-based matrix component 640 of the second foam layer 608 may be a flexible polyurethane layer, which is reacted from isocyanate and polyol.

According to yet other embodiments, the flame retardant filler component 650 may be selected from a particular group of materials. For example, the flame retardant filler component 650 may be a filler selected from the group consisting of reactive charring agents, mineral compounds, endothermic decomposition compounds, and any combination thereof.

According to still other embodiments, the flame retardant filler component 650 may include a particular material. For example, the flame retardant filler component 650 may include reactive charring agents. It will again be appreciated that a reactive charring agent may be defined as a compound that can react with a carbon source, such as a polymer material, at high temperatures to form a carbon layer. According to still other embodiments, the flame retardant filler component 650 may include melamine. According to yet other embodiments, the flame retardant filler component 650 may include organic phosphorous compounds. According to still other embodiments, the flame retardant filler component 650 may include inorganic phosphorous compounds. According to yet other embodiments, the flame retardant filler component 650 may include metal salts. According to yet other embodiments, the flame retardant filler component 650 may include mineral compounds. According to still other embodiments, the flame retardant filler component 650 may include endothermic decomposition compounds. According to other embodiments, the flame retardant filler component 650 may include any combination of reactive charring agents, melamine, organic phosphorous compounds, inorganic phosphorous compounds, metal salts, mineral compounds, or endothermic decomposition compounds.

According to still other embodiments, the flame retardant filler component 650 may consist of a particular material. For example, the flame retardant filler component 650 may consist of reactive charring agents. According to still other embodiments, the flame retardant filler component 650 may consist of melamine. According to yet other embodiments, the flame retardant filler component 650 may consist of organic phosphorous compounds. According to still other embodiments, the flame retardant filler component 650 may consist of inorganic phosphorous compounds. According to yet other embodiments, the flame retardant filler component 650 may consist of metal salts. According to yet other embodiments, the flame retardant filler component 650 may consist of mineral compounds. According to still other embodiments, the flame retardant filler component 650 may consist of endothermic decomposition compounds. According to other embodiments, the flame retardant filler component 650 may consist of any combination of reactive charring agents, melamine, organic phosphorous compounds, inorganic phosphorous compounds, metal salts, mineral compounds, or endothermic decomposition compounds.

According to still other embodiments, the flame retardant filler component 650 may be a filler of a particular material. For example, the flame retardant filler component 650 may be a filler of reactive charring agents. According to still other embodiments, the flame retardant filler component 650 may be a filler of melamine. According to yet other embodiments, the flame retardant filler component 650 may be a filler of organic phosphorous compounds. According to still other embodiments, the flame retardant filler component 650 may be a filler of inorganic phosphorous compounds. According to yet other embodiments, the flame retardant filler component 650 may be a filler of metal salts. According to yet other embodiments, the flame retardant filler component 650 may be a filler of mineral compounds. According to still other embodiments, the flame retardant filler component 650 may be a filler of endothermic decomposition compounds. According to other embodiments, the flame retardant filler component 650 may be a filler of any combination of reactive charring agents, melamine, organic phosphorous compounds, inorganic phosphorous compounds, metal salts, mineral compounds, or endothermic decomposition compounds.

According to yet other embodiments, the flame retardant filler component 650 may include a particular organic phosphorous compound or inorganic phosphorous compound. For example, the flame retardant filler component 650 may include a phosphate. According to yet other embodiments, the flame retardant filler component 650 may include a phosphonate. According to yet other embodiments, the flame retardant filler component 650 may include a phosphinate. According to a particular embodiment, the flame retardant filler component 650 may include any combination of a phosphate, a phosphonate, or a phosphinate.

According to yet other embodiments, the flame retardant filler component 650 may consist of a particular organic phosphorous compound or inorganic phosphorous compound. For example, the flame retardant filler component 650 may consist of a phosphate. According to yet other embodiments, the flame retardant filler component 650 may consist of a phosphonate. According to yet other embodiments, the flame retardant filler component 650 may consist of a phosphinate. According to a particular embodiment, the flame retardant filler component 650 may consist of any combination of a phosphate, a phosphonate, or a phosphinate.

According to yet other embodiments, the flame retardant filler component 650 may be a filler of a particular organic phosphorous compound or inorganic phosphorous compound. For example, the flame retardant filler component 650 may be a filler of a phosphate. According to yet other embodiments, the flame retardant filler component 650 may be a filler of a phosphonate. According to yet other embodiments, the flame retardant filler component 650 may be a filler of a phosphinate. According to a particular embodiment, the flame retardant filler component 650 may be a filler of any combination of a phosphate, a phosphonate, or a phosphinate.

According to still other embodiments, the flame retardant filler component 650 may include a particular metal salt. For example, the flame retardant filler component 650 may include aluminum diethyl phosphinate.

According to still other embodiments, the flame retardant filler component 650 may consist of a particular metal salt. For example, the flame retardant filler component 650 may consist of aluminum diethyl phosphinate.

According to still other embodiments, the flame retardant filler component 650 may be a filler of a particular metal salt. For example, the flame retardant filler component 650 may be a filler of aluminum diethyl phosphinate. According to still other embodiments, the flame retardant filler component 650 may include a particular mineral compound. For example, the flame retardant filler component 650 may include expandable graphite.

According to still other embodiments, the flame retardant filler component 650 may consist of a particular mineral compound. For example, the flame retardant filler component 650 may consist of expandable graphite.

According to still other embodiments, the flame retardant filler component 650 may be a filler of a particular mineral compound. For example, the flame retardant filler component 650 may be an expandable graphite filler.

According to yet other embodiments, the flame retardant filler component 650 may include a particular endothermic decomposition compound. For example, the flame retardant filler component 650 may include a metal hydrate. According to still other embodiments, the flame retardant filler component 650 may include a metal silicate. According to yet other embodiments, the flame retardant filler component 650 may include a carbonate. According to a particular embodiment, the flame retardant filler component 650 may include aluminum trihydrate. According to still other embodiments, the flame retardant filler component 650 may include zinc borate. According to yet other embodiments, the flame retardant filler component 650 may include any combination of a metal hydrate, a metal silicate, a carbonate, aluminum trihydrate, or zinc borate.

According to yet other embodiments, the flame retardant filler component 650 may consist of a particular endothermic decomposition compound. For example, the flame retardant filler component 650 may consist of a metal hydrate. According to still other embodiments, the flame retardant filler component 650 may consist of a metal silicate. According to yet other embodiments, the flame retardant filler component 650 may consist of a carbonate. According to a particular embodiment, the flame retardant filler component 650 may consist of aluminum trihydrate. According to still other embodiments, the flame retardant filler component 650 may consist of zinc borate. According to yet other embodiments, the flame retardant filler component 650 may consist of any combination of a metal hydrate, a metal silicate, a carbonate, aluminum trihydrate, or zinc borate.

According to yet other embodiments, the flame retardant filler component 650 may be a filler of a particular endothermic decomposition compound. For example, the flame retardant filler component 650 may be a metal hydrate filler. According to still other embodiments, the flame retardant filler component 650 may be a metal silicate filler. According to yet other embodiments, the flame retardant filler component 650 may be a carbonate filler. According to a particular embodiment, the flame retardant filler component 650 may be an aluminum trihydrate filler. According to still other embodiments, the flame retardant filler component 650 may be a filler of zinc borate. According to yet other embodiments, the flame retardant filler component 650 may be a filler of any combination of a metal hydrate, a metal silicate, a carbonate, aluminum trihydrate, or zinc borate.

According to certain embodiments, the second foam layer 608 may include a particular content of the polyurethane-based matrix component 640. For example, the second foam layer 608 may include a polyurethane-based matrix component content of at least about 40 wt. % for a total weight of the second foam layer 608, such as, at least about 45 wt. % or at least about 50 wt. % or at least about 55 wt. % or at least about 60 wt. % or at least about 65 wt. % or even at least about 70 wt. %. According to yet other embodiments, the second foam layer 608 may include a polyurethane-based matrix component content of not greater than about 95 wt. % for a total weight of the second foam layer 608, such as, not greater than about 90 wt. % or not greater than about 85 wt. % or not greater than about 80 wt. % or even not greater than about 75 wt. %. It will be appreciated that the polyurethane-based matrix component content of the second foam layer 608 may be within a range between any of the values noted above. It will be further appreciated that the polyurethane-based matrix component content of the second foam layer 608 may be any value between any of the minimum and maximum values noted above.

According to still other embodiments, the second foam layer 608 may include a particular content of flame retardant filler component 650. For example, the second foam layer 608 may include a flame retardant filler component content of at least about 5 wt. % for a total weight of the second foam layer 608, such as, at least about 10 wt. % or at least about 15 wt. % or at least about 20 wt. % or at least about 25 wt. % or at least about 30 wt. % or even at least about 35 wt. %. According to yet other embodiments, the second foam layer 608 may include a flame retardant filler component content of not greater than about 60 wt. % for a total weight of the second foam layer 608, such as, not greater than about 55 wt. % or not greater than about 50 wt. % or not greater than about 45 wt. % or even not greater than about 40 wt. %. It will be appreciated that the flame retardant filler component content of the second foam layer 608 may be within a range between any of the values noted above. It will be further appreciated that the flame retardant filler component content of the second foam layer 608 may be any value between any of the minimum and maximum values noted above.

According to certain embodiments, the second foam layer 608 may have a particular flammability rating as measured according to ASTM D4986. In particular, the foam layer may have a HBF flammability rating as measured according to ASTM D4986.

According to certain embodiments, the second foam layer 608 may have a particular flammability rating as measured according to ASTM D3801. In particular, the foam layer may have a V-0 flammability rating as measured according to ASTM D3801.

According to still other embodiments, the second foam layer 608 may have a particular cold-side temperature as measured at 5 minutes when a 3 mm thickness of the foam is exposed to a hot plate test at 650° C. For purposes of embodiments described herein, the hot plate test is carried out by preparing a 1 inch by 1 inch specimen of the material, which is put on top of a hot plate. Then a thermal couple is fixed in a steel weight (1 inch in diameter, 2 inches in height) is put on top of the specimen to measure the cold side surface temperature. According to certain embodiments, the second foam layer 608 may have a cold side temperature of not greater than about 300° C., such as, not greater than about 275° C. or not greater than about 250° C. or not greater than about 225 or not greater than about 200° C. or not greater than about 175° C. or even not greater than about 150° C. According to still other embodiments, the second foam layer 608 may have a cold side temperature of at least about 25° C. It will be appreciated that the cold side temperature of the second foam layer 608 may be within a range between any of the values noted above. It will be further appreciated that the cold side temperature of the second foam layer 608 may be any value between any of the values noted above.

According to yet other embodiments, the second foam layer 608 may have a particular thickness. For example, the second foam layer 608 may have a thickness of at least about 0.5 mm, such as, at least about 1.0 mm or at least about 1.5 mm or at least about 2.0 mm or at least about 2.5 mm or at least about 3.0 mm or at least about 3.5 mm or at least about 4.0 mm or at least about 4.5 mm or even at least about 5.0 mm. According to still other embodiments, the second foam layer 608 may have a thickness of not greater than about 10 mm, such as, not greater than about 9.5 mm or not greater than about 9.0 mm or not greater than about 8.5 mm or not greater than about 8.0 mm or not greater than about 7.5 mm or not greater than about 7.0 mm or not greater than about 6.5 mm or even not greater than about 6.0 mm. It will be appreciated that the thickness of the second foam layer 608 may be within a range between any of the minimum and maximum values noted above. It will be further appreciated that the thickness of the second foam layer 608 may be any value between any of the minimum and maximum values noted above.

According to yet other embodiments, the second foam layer 608 may have a particular 25% strain compression rating. For purposes of embodiments described herein, the 25% strain compression rating is defined as the compression rating of a sample measure at a 25% strain and is determined by measuring the force-to-compress and compression-force-deflection of the sample at a 25% strain. Force-to-compress (FTC) is defined as the peak force (or stress) to compress the sample to a predetermined strain and compression-force-deflection (CFD) is defined as the plateau or relaxation force (or stress) retained by a sample when held at the desired strain (i.e., 25%). Measurements are made using a Texture Analyzer, which finds and records both FTC values and CFD values after a hold time of 60 seconds, a compression speed of 0.16 mm/s and a trigger force of 10 grams.

According to certain embodiments, the second foam layer 608 may have a 25% strain compression rating of not greater than about 500 kPa, such as, not greater than about 475 kPa or not greater than about 450 kPa or not greater than about 425 kPa or not greater than about 400 kPa or not greater than about 375 kPa or not greater than about 350 kPa or not greater than about 325 kPa or not greater than about 300 kPa or not greater than about 275 kPa or not greater than about 250 kPa or not greater than about 225 kPa or not greater than about 200 kPa or not greater than about 175 kPa or not greater than about 150 kPa or not greater than about 125 kPa or not greater than about 100 kPa. According to still other embodiments, the second foam layer 608 may have a 25% strain compression rating of at least about 5 kPa, such as, at least about 10 kPa or at least about 15 kPa or at least about 20 kPa or at least about 25 kPa. It will be appreciated that the 25% strain compression rating of the second foam layer 608 may be within a range between any of the minimum and maximum values noted above. It will be further appreciated that the 50% strain compression rating of the second foam layer 608 may be any value between any of the minimum and maximum values noted above.

According to yet other embodiments, the second foam layer 608 may have a particular density. For the purpose of embodiments described herein, the density of the second foam layer 608 may be determined according to ASTM D1056. According to certain embodiments, the second foam layer 608 may have a density of not greater than about 600 kg/m³, such as, not great than about 575 kg/m³ or not greater than about 550 kg/m³ or not greater than about 525 kg/m³ or not greater than about 500 kg/m³ or not greater than about 450 kg/m³ or not greater than about 400 kg/m³ or not greater than about 350 kg/m³ or even not greater than about 300 kg/m³. According to yet other embodiments, the second foam layer 608 may have a density of at least about 50 kg/m³, such as, at least about 60 kg/m³ or at least about 80 kg/m³ or at least about 100 kg/m³ or at least about 120 kg/m³ or at least about 140 kg/m³ or at least about 160 kg/m³ or at least about 180 kg/m³ or at least about 200 kg/m³ or at least about 220 kg/m³ or even at least about 240 kg/m³. It will be appreciated that the density of the second foam layer 608 may be within a range between any of the minimum and maximum values noted above. It will be further appreciated that the density of the second foam layer 608 may be any value between any of the minimum and maximum values noted above.

According to yet other embodiments, the second foam layer 608 may have a particular thermal conductivity as measured according to ASTM C518. For example, the second foam layer 608 may have a thermal conductivity of at least about 0.01 W/mK, such as, at least about 0.02 W/mK or at least about 0.03 W/mK or at least about 0.04 W/mK or even at least about 0.05 W/mK. According to still other embodiments, the second foam layer 608 may have a thermal conductivity of not greater than about 0.15 W/mK, such as, not greater than about 0.14 W/mK or not greater than about 0.13 W/mK or not greater than about 0.12 W/mK or not greater than about 0.11 W/mK or not greater than about 0.10 W/mK not greater than about 0.09 W/mK or not greater than about 0.08 W/mK or even not greater than about 0.07 W/mK. It will be appreciated that the thermal conductivity of the second foam layer 608 may be within a range between any of the minimum and maximum values noted above. It will be further appreciated that the thermal conductivity of the second foam layer 608 may be any value between any of the minimum and maximum values noted above.

According to certain embodiments, the thermal barrier composite described herein may be formed according to any acceptable forming process for a thermal barrier composite. According to a particular embodiment, the thermal barrier composite may be formed using a lamination process where the porous foam and barrier layer are laminated using a transfer adhesive such as, for example, a silicon adhesive, a rubber adhesive, an acrylic adhesive, a phenolic adhesive, a polyurethane-based adhesive or any combination thereof. According to still other embodiments, the thermal barrier composite may be formed using a lamination process with a porous foam and a coated barrier layer, where the coating on the barrier layer is an adhesive, such as, a silicon adhesive, a rubber adhesive, an acrylic adhesive, a phenolic adhesive, a polyurethane-based adhesive or any combination thereof. According to still other embodiments, the thermal barrier composite may be formed using a direct cast forming process, wherein the foam is directly cast onto the barrier films or between the barrier films.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A multilayer composite comprising: a first barrier layer, and a first foam layer comprising a polyurethane-based matrix component, and a flame retardant filler component, wherein the multilayer composite comprises a HBF flammability rating as measured according to ASTM D4986.

Embodiment 2. A multilayer composite comprising: a first barrier layer, and a first foam layer comprising a polyurethane-based matrix component, and a flame retardant filler component, wherein the first barrier layer comprises a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof, and wherein the flame retardant filler component comprises a filler selected from the group consisting of reactive charring agents, mineral compounds, endothermic decomposition compounds, and any combination thereof.

Embodiment 3. The multilayer composite of any one of embodiments 1 and 2, wherein the polyurethane-based matrix component of the first foam layer comprises a flexible polyurethane reacted from isocyanate and polyol.

Embodiment 4. The multilayer composite of any one of embodiments 1 and 2, wherein the reactive charring agents are selected from the group consisting of melamine, organic phosphorous compounds, inorganic phosphorous compounds, metal salts, such as phosphate, phosphonate, phosphinate, aluminum diethyl phosphinate, and any combination thereof; and/or, the mineral compounds are selected from the group consisting of expandable graphite; and/or, the endothermic decomposition compounds are selected from the group consisting of metal hydrate, metal silicates, carbonates, such as aluminum trihydrate and zinc borate, and any combination thereof.

Embodiment 5. The multilayer composite of any one of embodiments 1 and 2, wherein the first foam layer comprises a polyurethane-based matrix component content of at least about 40 wt. % for a total weight of the first foam layer.

Embodiment 6. The multilayer composite of any one of embodiments 1 and 2, wherein the first foam layer comprises a polyurethane-based matrix component content of not greater than about 95 wt. % for a total weight of the first foam layer.

Embodiment 7. The multilayer composite of any one of embodiments 1 and 2, wherein the first foam layer comprises a flame retardant filler component content of at least about 5 wt. % for a total weight of the first foam layer.

Embodiment 8. The multilayer composite of any one of embodiments 1 and 2, wherein the first foam layer comprises a flame retardant filler component of not greater than about 60 wt. % for a total weight of the first foam layer.

Embodiment 9. The multilayer composite of any one of embodiments 1 and 2, wherein the first foam layer comprises a HBF flammability rating as measured according to ASTM D4986.

Embodiment 10. The multilayer composite of any one of embodiments 1 and 2, wherein the multilayer composite comprises a HBF flammability rating as measured according to ASTM D4986.

Embodiment 11. The multilayer composite of any one of embodiments 1 and 2, wherein the multilayer composite comprises a cold side temperature of not greater than about 300° C. as measured at 5 minutes when exposed to a hotplate test at 650° C.

Embodiment 12. The multilayer composite of any one of embodiments 1 and 2, wherein the multilayer composite comprises a cold side temperature of at least about 25° C. as measured at 5 minutes when exposed to a hotplate test at 650° C.

Embodiment 13. The multilayer composite of any one of embodiments 1 and 2, wherein the first foam layer comprises a thickness of at least about 0.5 mm.

Embodiment 14. The multilayer composite of any one of embodiments 1 and 2, wherein the first foam layer comprises a thickness of not greater than about 10 mm.

Embodiment 15. The multilayer composite of any one of embodiments 1 and 2, wherein the multilayer composite comprises a thickness of at least about 0.5 mm.

Embodiment 16. The multilayer composite of any one of embodiments 1 and 2, wherein the multilayer composite comprises a thickness of not greater than about 10 mm.

Embodiment 17. The multilayer composite of any one of embodiments 1 and 2, wherein the first foam layer comprises a 25% strain compression rating of at least about 5 kPa.

Embodiment 18. The multilayer composite of any one of embodiments 1 and 2, wherein the first foam layer comprises a 25% strain compression rating of not greater than about 500 kPa.

Embodiment 19. The multilayer composite of any one of embodiments 1 and 2, wherein the multilayer composite comprises a 25% strain compression rating of at least about 5 kPa.

Embodiment 20. The multilayer composite of any one of embodiments 1 and 2, wherein the multilayer composite comprises a 25% strain compression rating of not greater than about 500 kPa.

Embodiment 21. The multilayer composite of any one of embodiments 1 and 2, wherein the first foam layer comprises a density of not greater than about 600 kg/m³.

Embodiment 22. The multilayer composite of any one of embodiments 1 and 2, wherein the first foam layer comprises a density of at least about 50 kg/m³.

Embodiment 23. The multilayer composite of any one of embodiments 1 and 2, wherein the multilayer composite layer comprises a density of not greater than about 600 kg/m³.

Embodiment 24. The multilayer composite of any one of embodiments 1 and 2, wherein the multilayer composite comprises a density of at least about 50 kg/m³.

Embodiment 25. The multilayer composite of any one of embodiments 1 and 2, wherein the first foam layer comprises a thermal conductivity of at least about 0.01 W/mK.

Embodiment 26. The multilayer composite of any one of embodiments 1 and 2, wherein the first foam layer comprises a thermal conductivity of not greater than about 0.15 W/mK.

Embodiment 27. The multilayer composite of any one of embodiments 1 and 2, wherein the multilayer composite comprises a thermal conductivity of at least about 0.01 W/mK.

Embodiment 28. The multilayer composite of any one of embodiments 1 and 2, wherein the multilayer composite comprises a thermal conductivity of not greater than about 0.15 W/mK.

Embodiment 29. The multilayer composite of any one of embodiments 1 and 2, wherein the first barrier layer comprises a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

Embodiment 30. The multilayer composite of any one of embodiments 1 and 2, wherein the first barrier layer has a thickness of at least about 0.05 mm.

Embodiment 31. The multilayer composite of any one of embodiments 1 and 2, wherein the first barrier layer has a thickness of not greater than about 7 mm.

Embodiment 32. The multilayer composite of any one of embodiments 1 and 2, wherein the multilayer composite further comprises a second barrier layer and wherein the first foam layer is between the first barrier layer and the second barrier layer.

Embodiment 33. The multilayer composite of embodiment 32, wherein the second barrier layer comprises a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

Embodiment 34. The multilayer composite of embodiment 32, wherein the second barrier layer has a thickness of at least about 0.05 mm.

Embodiment 35. The multilayer composite of embodiment 32, wherein the second barrier layer has a thickness of not greater than about 7 mm.

Embodiment 36. The multilayer composite of any one of embodiments 1 and 2, wherein the multilayer composite further comprises a second foam layer and a second barrier layer, wherein the second for a layer comprises a polyurethane-based matrix component and a flame retardant filler component, and wherein the first foam layer and the second foam layer are both between the first barrier layer and the second barrier layer.

Embodiment 37. The multilayer composite of embodiment 36, wherein the second barrier layer comprises a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

Embodiment 38. The multilayer composite of embodiment 36, wherein the second barrier layer has a thickness of at least about 0.05 mm.

Embodiment 39. The multilayer composite of embodiment 36, wherein the second barrier layer has a thickness of not greater than about 7 mm.

Embodiment 40. The multilayer composite of embodiment 36, wherein the polyurethane-based matrix component of the second foam layer comprises a flexible polyurethane reacted from isocyanate and polyol.

Embodiment 41. The multilayer composite of embodiment 36, wherein the flame retardant filler component of the second foam layer comprises a filler selected from the group consisting of reactive charring agents, mineral compounds, endothermic decomposition compounds, and any combination thereof.

Embodiment 42. The multilayer composite of embodiment 36, wherein the second foam layer comprises a polyurethane-based matrix component content of at least about 40 wt. % for a total weight of the second foam layer.

Embodiment 43. The multilayer composite of embodiment 36, wherein the second foam layer comprises a polyurethane-based matrix component content of not greater than about 95 wt. % for a total weight of the second foam layer.

Embodiment 44. The multilayer composite of embodiment 36, wherein the second foam layer comprises a flame retardant filler component content of at least about 5 wt. % for a total weight of the second foam layer.

Embodiment 45. The multilayer composite of embodiment 36, wherein the second foam layer comprises a flame retardant filler component of not greater than about 60 wt. % for a total weight of the second foam layer.

Embodiment 46. The multilayer composite of embodiment 36, wherein the second foam layer comprises a HBF flammability rating as measured according to ASTM D4986.

Embodiment 47. The multilayer composite of embodiment 36, wherein the second foam layer comprises a cold side temperature of not greater than about 300° C. as measured at 5 minutes when exposed to a hotplate test at 650° C.

Embodiment 48. The multilayer composite of embodiment 36, wherein the second foam layer comprises a cold side temperature of at least about 25° C. as measured at 5 minutes when exposed to a hotplate test at 650° C.

Embodiment 49. The multilayer composite of embodiment 36, wherein the second foam layer comprises a thickness of at least about 0.5 mm.

Embodiment 50. The multilayer composite of embodiment 36, wherein the second foam layer comprises a thickness of not greater than about 10 mm.

Embodiment 51. The multilayer composite of embodiment 36, wherein the second foam layer comprises a 25% strain compression rating of at least about 5 kPa.

Embodiment 52. The multilayer composite of embodiment 36, wherein the second foam layer comprises a 25% strain compression rating of not greater than about 500 kPa.

Embodiment 53. The multilayer composite of embodiment 36, wherein the second foam layer comprises a density of not greater than about 600 kg/m³.

Embodiment 54. The multilayer composite of embodiment 36, wherein the second foam layer comprises wherein the foam layer comprises a density of at least about 50 kg/m³.

Embodiment 55. The multilayer composite of embodiment 36, wherein the second foam layer comprises a thermal conductivity of at least about 0.01 W/mK.

Embodiment 56. The multilayer composite of embodiment 36, wherein the second foam layer comprises a thermal conductivity of not greater than about 0.15 W/mK.

Embodiment 57. A thermal barrier comprising: a first barrier layer, and a first foam layer comprising a polyurethane-based matrix component, and a flame retardant filler component, wherein the thermal barrier comprises a HBF flammability rating as measured according to ASTM D4986.

Embodiment 58. A thermal barrier comprising: a first barrier layer, and a first foam layer comprising a polyurethane-based matrix component, and a flame retardant filler component, wherein the first barrier layer comprises a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof, and wherein the flame retardant filler component comprises a filler selected from the group consisting of reactive charring agents, mineral compounds, endothermic decomposition compounds, and any combination thereof.

Embodiment 59. The thermal barrier of any one of embodiments 57 and 58, wherein the polyurethane-based matrix component of the first foam layer comprises a flexible polyurethane reacted from isocyanate and polyol.

Embodiment 60. The thermal barrier of any one of embodiments 57 and 58, wherein the reactive charring agents are selected from the group consisting of melamine, organic phosphorous compounds, inorganic phosphorous compounds, metal salts, such as phosphate, phosphonate, phosphinate, aluminum diethyl phosphinate, and any combination thereof; and/or, the mineral compounds are selected from the group consisting of expandable graphite; and/or, the endothermic decomposition compounds are selected from the group consisting of metal hydrate, metal silicates, carbonates, such as aluminum trihydrate and zinc borate, and any combination thereof.

Embodiment 61. The thermal barrier of any one of embodiments 57 and 58, wherein the first foam layer comprises a polyurethane-based matrix component content of at least about 40 wt. % for a total weight of the first foam layer.

Embodiment 62. The thermal barrier of any one of embodiments 57 and 58, wherein the first foam layer comprises a polyurethane-based matrix component content of not greater than about 95 wt. % for a total weight of the first foam layer.

Embodiment 63. The thermal barrier of any one of embodiments 57 and 58, wherein the first foam layer comprises a flame retardant filler component content of at least about 5 wt. % for a total weight of the first foam layer.

Embodiment 64. The thermal barrier of any one of embodiments 57 and 58, wherein the first foam layer comprises a flame retardant filler component of not greater than about 60 wt. % for a total weight of the first foam layer.

Embodiment 65. The thermal barrier of any one of embodiments 57 and 58, wherein the first foam layer comprises a HBF flammability rating as measured according to ASTM D4986.

Embodiment 66. The thermal barrier of any one of embodiments 57 and 58, wherein the thermal barrier comprises a HBF flammability rating as measured according to ASTM D4986.

Embodiment 67. The thermal barrier of any one of embodiments 57 and 58, wherein the thermal barrier comprises a cold side temperature of not greater than about 300° C. as measured at 5 minutes when exposed to a hotplate test at 650° C.

Embodiment 68. The thermal barrier of any one of embodiments 57 and 58, wherein the thermal barrier comprises a cold side temperature of at least about 25° C. as measured at 5 minutes when exposed to a hotplate test at 650° C.

Embodiment 69. The thermal barrier of any one of embodiments 57 and 58, wherein the first foam layer comprises a thickness of at least about 0.5 mm.

Embodiment 70. The thermal barrier of any one of embodiments 57 and 58, wherein the first foam layer comprises a thickness of not greater than about 10 mm.

Embodiment 71. The thermal barrier of any one of embodiments 57 and 58, wherein the thermal barrier comprises a thickness of at least about 0.5 mm.

Embodiment 72. The thermal barrier of any one of embodiments 57 and 58, wherein the thermal barrier comprises a thickness of not greater than about 10 mm.

Embodiment 73. The thermal barrier of any one of embodiments 57 and 58, wherein the first foam layer comprises a 25% strain compression rating of at least about 5 kPa.

Embodiment 74. The thermal barrier of any one of embodiments 57 and 58, wherein the first foam layer comprises a 25% strain compression rating of not greater than about 500 kPa.

Embodiment 75. The thermal barrier of any one of embodiments 57 and 58, wherein the thermal barrier comprises a 25% strain compression rating of at least about 5 kPa.

Embodiment 76. The thermal barrier of any one of embodiments 57 and 58, wherein the thermal barrier comprises a 25% strain compression rating of not greater than about 500 kPa.

Embodiment 77. The thermal barrier of any one of embodiments 57 and 58, wherein the first foam layer comprises a density of not greater than about 600 kg/m³.

Embodiment 78. The thermal barrier of any one of embodiments 57 and 58, wherein the first foam layer comprises a density of at least about 50 kg/m³.

Embodiment 79. The thermal barrier of any one of embodiments 57 and 58, wherein the thermal barrier comprises a density of not greater than about 600 kg/m³.

Embodiment 80. The thermal barrier of any one of embodiments 57 and 58, wherein the thermal barrier comprises a density of at least about 50 kg/m³.

Embodiment 81. The thermal barrier of any one of embodiments 57 and 58, wherein the first foam layer comprises a thermal conductivity of at least about 0.01 W/mK.

Embodiment 82. The thermal barrier of any one of embodiments 57 and 58, wherein the first foam layer comprises a thermal conductivity of not greater than about 0.15 W/mK.

Embodiment 83. The thermal barrier of any one of embodiments 57 and 58, wherein the thermal barrier comprises a thermal conductivity of at least about 0.01 W/mK.

Embodiment 84. The thermal barrier of any one of embodiments 57 and 58, wherein the thermal barrier comprises a thermal conductivity of not greater than about 0.15 W/mK.

Embodiment 85. The thermal barrier of any one of embodiments 57 and 58, wherein the first barrier layer comprises a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

Embodiment 86. The thermal barrier of any one of embodiments 57 and 58, wherein the first barrier layer has a thickness of at least about 0.05 mm.

Embodiment 87. The thermal barrier of any one of embodiments 57 and 58, wherein the first barrier layer has a thickness of not greater than about 7 mm.

Embodiment 88. The thermal barrier of any one of embodiments 57 and 58, wherein the thermal barrier further comprises a second barrier layer and wherein the first foam layer is between the first barrier layer and the second barrier layer.

Embodiment 89. The thermal barrier of embodiment 88, wherein the second barrier layer comprises a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

Embodiment 90. The thermal barrier of embodiment 88, wherein the second barrier layer has a thickness of at least about 0.05 mm.

Embodiment 91. The thermal barrier of embodiment 88, wherein the second barrier layer has a thickness of not greater than about 7 mm.

Embodiment 92. The thermal barrier of any one of embodiments 57 and 58, wherein the thermal barrier further comprises a second foam layer and a second barrier layer, wherein the second for a layer comprises a polyurethane-based matrix component and a flame retardant filler component, and wherein the first foam layer and the second foam layer are both between the first barrier layer and the second barrier layer.

Embodiment 93. The thermal barrier of embodiment 92, wherein the second barrier layer comprises a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

Embodiment 94. The thermal barrier of embodiment 92, wherein the second barrier layer has a thickness of at least about 0.05 mm.

Embodiment 95. The thermal barrier of embodiment 92, wherein the second barrier layer has a thickness of not greater than about 7 mm.

Embodiment 96. The thermal barrier of embodiment 92, wherein the polyurethane-based matrix component of the second foam layer comprises a flexible polyurethane reacted from isocyanate and polyol.

Embodiment 97. The thermal barrier of embodiment 92, wherein the flame retardant filler component of the second foam layer comprises a filler selected from the group consisting of reactive charring agents, mineral compounds, endothermic decomposition compounds, and any combination thereof.

Embodiment 98. The thermal barrier of embodiment 92, wherein the second foam layer comprises a polyurethane-based matrix component content of at least about 40 wt. % for a total weight of the second foam layer.

Embodiment 99. The thermal barrier of embodiment 92, wherein the second foam layer comprises a polyurethane-based matrix component content of not greater than about 95 wt. % for a total weight of the second foam layer.

Embodiment 100. The thermal barrier of embodiment 92, wherein the second foam layer comprises a flame retardant filler component content of at least about 5 wt. % for a total weight of the second foam layer.

Embodiment 101. The thermal barrier of embodiment 92, wherein the second foam layer comprises a flame retardant filler component of not greater than about 60 wt. % for a total weight of the second foam layer.

Embodiment 102. The thermal barrier of embodiment 92, wherein the second foam layer comprises a HBF flammability rating as measured according to ASTM D4986.

Embodiment 103. The thermal barrier of embodiment 92, wherein the second foam layer comprises a cold side temperature of not greater than about 300° C. as measured at 5 minutes when exposed to a hotplate test at 650° C.

Embodiment 104. The thermal barrier of embodiment 92, wherein the second foam layer comprises a cold side temperature of at least about 25° C. as measured at 5 minutes when exposed to a hotplate test at 650° C.

Embodiment 105. The thermal barrier of embodiment 92, wherein the second foam layer comprises a thickness of at least about 0.5 mm.

Embodiment 106. The thermal barrier of embodiment 92, wherein the second foam layer comprises a thickness of not greater than about 10 mm.

Embodiment 107. The thermal barrier of embodiment 92, wherein the second foam layer comprises a 25% strain compression rating of at least about 5 kPa.

Embodiment 108. The thermal barrier of embodiment 92, wherein the second foam layer comprises a 25% strain compression rating of not greater than about 500 kPa.

Embodiment 109. The thermal barrier of embodiment 92, wherein the second foam layer comprises a density of not greater than about 600 kg/m³.

Embodiment 110. The thermal barrier of embodiment 92, wherein the second foam layer comprises a density of at least about 50 kg/m³.

Embodiment 111. The thermal barrier of embodiment 92, wherein the second foam layer comprises a thermal conductivity of at least about 0.01 W/mK.

Embodiment 112. The thermal barrier of embodiment 92, wherein the second foam layer comprises a thermal conductivity of not greater than about 0.15 W/mK.

### EXAMPLES

The concepts described herein will be further described in the following Examples, which do not limit the scope of the invention described in the claims.

### Example 1

Three sample multilayer composites S1, S2, and S3, were formed according to embodiments described herein. Three comparative sample multilayer composites CS1, CS2, CS3, CS4 and CS5 were formed for comparison to the sample multilayer composites S1-S3. The construction and composition of each multilayer composite S1-S3 and comparative sample multilayer composites CS1-CS5 are summarized in table 1 below.

TABLE 1
Multilayer Composite Construction/Composition

| | | | Foam Layer Composition | |
|---|---|---|---|---|
| | | | (wt. % for a total weight | |
| | | | of the foam layer) | |
| | | | | Flame |
| | Sample | | Polyurethane- | Retardant |
| | Thickness | Barrier | Based Matrix | Filler |
| Sample | (mm) | Layer | Component | Component |
| S1 | 3.5 | 0.2 mm | 90 | 10 |
| | | Mica | | |
| S2 | 3.5 | 0.2 mm | 73 | 27 |
| | | Mica | | |
| S3 | 4.5 | 0.2 mm | 63 | 37 |
| | | Mica | | |
| CS1 | 2.0 | None | 90 | 10 |
| CS2 | 3.0 | None | 73 | 27 |
| CS3 | 1.6 | None | 65 | 35 |
| CS4 | 4.0 | None | 63 | 37 |
| CS5 | 2.1 | 0.2 mm | 65 | 35 |
| | | Mica | | |

The performance ratings (i.e., the flame resistance rating, self-ignition time, burn through time, and cold-side temperature) of the sample multilayer composites S1-S6, and the comparative sample multilayer composite CS1 are summarized in Table 2 below. It will be appreciated that the flame resistance rating is based on the sample's performance in a UL94 VO test, the self-ignition time is measured in a 650° C. hot plate test as described herein, the burn through time is measured in a 1000° C. torch test as described herein and the cold-side temperature is measured in a 650° C. hot plate test as described herein.

TABLE 2
Foam Layer Performance

| | Flame | Self- | | Cold-Side | Burn | | Cold-Side |
|---|---|---|---|---|---|---|---|
| | Resis- | Ignition | | Temperature | through | | Temperature |
| | tance | Time in | | at 5 min in | Time in | | at 6 min in |
| Sam- | Rating | 650° C. Hot | | 650° C. Hot | 1000° C. | | 1000° C. |
| ple | (UL94) | Plate Test | | Plate Test | Torch Test | | Torch Test |
| S1 | HBF | 7 | sec | 275° C. | >6 | min | 385° C. |
| S2 | V0 | >5 | min | 196° C. | >6 | min | 381° C. |
| S3 | V0 | >5 | min | 202° C. | >6 | min | 330° C. |
| CS1 | HBF | — | | — | <30 | sec | N/A |
| CS2 | V0 | — | | — | <30 | sec | N/A |
| CS3 | None | — | | — | <30 | sec | N/A |
| CS4 | V0 | >5 | min | 539° C. | <30 | sec | N/A |
| CS5 | None | 8 | sec | 305° C. | >6 | min | 450° C. |

Note that not all of the activities described above in the general description, or the examples, are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A multilayer composite comprising:
a first barrier layer, and
a first foam layer comprising a polyurethane-based matrix component, and a flame retardant filler component,
wherein the multilayer composite comprises a HBF flammability rating as measured according to ASTM D4986.

2. The multilayer composite of claim 1, wherein the polyurethane-based matrix component of the first foam layer comprises a flexible polyurethane reacted from isocyanate and polyol.

3. The multilayer composite of claim 1, wherein the reactive charring agents are selected from the group consisting of melamine, organic phosphorous compounds, inorganic phosphorous compounds, metal salts, such as phosphate, phosphonate, phosphinate, aluminum diethyl phosphinate, and any combination thereof; and/or,
the mineral compounds are selected from the group consisting of expandable graphite; and/or,
the endothermic decomposition compounds are selected from the group consisting of metal hydrate, metal silicates, carbonates, such as aluminum trihydrate and zinc borate, and any combination thereof.

4. The multilayer composite of claim 1, wherein the first foam layer comprises a polyurethane-based matrix component content of at least about 40 wt. % and not greater than about 95 wt. % for a total weight of the first foam layer.

5. The multilayer composite of claim 1, wherein the first foam layer comprises a flame retardant filler component content of at least about 5 wt. % and not greater than about 60 wt. % for a total weight of the first foam layer.

6. The multilayer composite of claim 1, wherein the first foam layer comprises a HBF flammability rating as measured according to ASTM D4986.

7. The multilayer composite of claim 1, wherein the multilayer composite comprises a cold side temperature of not greater than about 300° C. as measured at 5 minutes when exposed to a hotplate test at 650° C.

8. The multilayer composite of claim 1, wherein the first foam layer comprises a thickness of at least about 0.5 mm and not greater than about 10 mm.

9. The multilayer composite of claim 1, wherein the multilayer composite comprises a thickness of at least about 0.5 mm and not greater than about 10 mm.

10. The multilayer composite of claim 1, wherein the first barrier layer comprises a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof.

11. The multilayer composite of claim 1, wherein the first barrier layer has a thickness of at least about 0.05 mm and not greater than about 7 mm.

12. The multilayer composite of claim 1, wherein the multilayer composite further comprises a second barrier layer and wherein the first foam layer is between the first barrier layer and the second barrier layer.

13. The multilayer composite of claim 1, wherein the multilayer composite further comprises a second foam layer and a second barrier layer, wherein the second for a layer comprises a polyurethane-based matrix component and a flame retardant filler component, and wherein the first foam layer and the second foam layer are both between the first barrier layer and the second barrier layer.

14. A multilayer composite comprising:
a first barrier layer, and
a first foam layer comprising a polyurethane-based matrix component, and a flame retardant filler component,
wherein the first barrier layer comprises a material selected from the group consisting of mica, a mica-fiber glass composite, a glass fabric, a silica fabric, a basalt fabric, a vermiculite coated glass fabric, an aerogel, a non-woven glass fabric, any combination thereof, and any laminate thereof, and
wherein the flame retardant filler component comprises a filler selected from the group consisting of reactive charring agents, mineral compounds, endothermic decomposition compounds, and any combination thereof.

15. The multilayer composite of claim 14, wherein the polyurethane-based matrix component of the first foam layer comprises a flexible polyurethane reacted from isocyanate and polyol.

16. The multilayer composite of claim 14, wherein the reactive charring agents are selected from the group consisting of melamine, organic phosphorous compounds, inorganic phosphorous compounds, metal salts, such as phosphate, phosphonate, phosphinate, aluminum diethyl phosphinate, and any combination thereof; and/or,
the mineral compounds are selected from the group consisting of expandable graphite; and/or,
the endothermic decomposition compounds are selected from the group consisting of metal hydrate, metal silicates, carbonates, such as aluminum trihydrate and zinc borate, and any combination thereof.

17. The multilayer composite of claim 14, wherein the first foam layer comprises a polyurethane-based matrix component content of at least about 40 wt. % and not greater than about 95 wt. % for a total weight of the first foam layer.

18. The multilayer composite of claim 14, wherein the first foam layer comprises a flame retardant filler component content of at least about 5 wt. % and not greater than about 60 wt. % for a total weight of the first foam layer.

19. The multilayer composite of claim 14, wherein the first foam layer comprises a HBF flammability rating as measured according to ASTM D4986.

20. A thermal barrier comprising:
a first barrier layer, and
a first foam layer comprising a polyurethane-based matrix component, and a flame retardant filler component,
wherein the thermal barrier comprises a HBF flammability rating as measured according to ASTM D4986.
